(19) United States
(12) Patent Application Publication
(10) Pub. No.: US 2026/0100865 A1
(43) Pub. Date: Apr. 9, 2026

(54) TECHNIQUES FOR A SOUNDING REFERENCE SIGNAL SECTION EXTENSION FOR CHANNEL ESTIMATION BY A RADIO UNIT

(71) Applicant: QUALCOMM Incorporated, San Diego, CA (US)

(72) Inventors: Abhishek Saurabh SACHIDANAND SINHA, San Diego, CA (US); Andrei Dragos RADULESCU, La Jolla, CA (US); Deepak AGARWAL, San Diego, CA (US); Jigneshkumar SHAH, San Diego, CA (US); Michael Francis GARYANTES, Bradley Beach, NJ (US)

(21) Appl. No.: 18/907,212

(22) Filed: Oct. 4, 2024

(51) Int. Cl. H04L 25/02; H04L 5/00; H04L 5/14

(52) U.S. Cl. CPC H04L 25/023; H04L 5/0053; H04L 5/14

(57) ABSTRACT

Various aspects of the present disclosure generally relate to wireless communication. In some aspects, a radio unit (RU) may receive, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions. The RU may transmit, as at least part of a second fronthaul C-plane message, one or more channel estimation measurement metrics that are based at least in part on the transmission configuration information. Numerous other aspects are described.

### FIELD OF THE DISCLOSURE

Aspects of the present disclosure generally relate to wireless communication and specifically relate to techniques, apparatuses, and methods associated with a sounding reference signal section extension for channel estimation by a radio unit.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a radio unit (RU). The method may include receiving, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions. The method may include transmitting, as at least part of a second fronthaul C-plane message, one or more channel estimation measurement metrics that are based at least in part on the transmission configuration information.

Some aspects described herein relate to a method of wireless communication performed by a distributed unit (DU). The method may include transmitting, as at least part of a first fronthaul C-plane message, an SRS section extension that indicates transmission configuration information associated two or more SRS ports and one or more transmissions that share one or more air interface resources that span multiple symbols and one or more frequency partitions. The method may include receiving, as at least part of a second fronthaul C-plane message, one or more channel estimation measurement metrics that are based at least in part on the transmission configuration information.

Some aspects described herein relate to a method of wireless communication performed by an RU. The method may include receiving, as at least part of a first fronthaul C-plane message, an SRS section extension that indicates transmission configuration information associated with two or more SRS port and one or more transmissions that share one or more air interface resources that span multiple symbols and one or more frequency partitions. The method may include transmitting, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of, multiple SRS ports, of the two or more SRS ports, in a same SRS section extensions, or multiple SRS ports that are indicated by multiple SRS section extensions.

Some aspects described herein relate to a method of wireless communication performed by an RU. The method may include receiving, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols. The method may include transmitting, as at least part of a second fronthaul C-plane message, one or more channel estimation measurement metrics that are based at least in part on the transmission configuration information.

Some aspects described herein relate to an apparatus for wireless communication at an RU. The apparatus may include one or more memories and one or more processors coupled to the one or more memories. The one or more processors may be configured, individually or collectively, to cause the apparatus to receive, as at least part of a first fronthaul C-plane message, an SRS section extension that indicates transmission configuration information associated with two or more SRS ports and one or more transmissions that share one or more air interface resources that span multiple symbols and one or more frequency partitions. The one or more processors may be configured, individually or collectively, to cause the apparatus to transmit, as at least part of a second fronthaul C-plane message, one or more channel estimation measurement metrics that are based at least in part on the transmission configuration information.

Some aspects described herein relate to an apparatus for wireless communication at a DU. The apparatus may include one or more memories and one or more processors coupled to the one or more memories. The one or more processors may be configured, individually or collectively, to cause the apparatus to transmit, as at least part of a first fronthaul C-plane message, an SRS section extension that indicates transmission configuration information associated two or more SRS ports and one or more transmissions that share one or more air interface resources that span multiple symbols and one or more frequency partitions. The one or more processors may be configured, individually or collectively, to cause the apparatus to receive, as at least part of a second fronthaul C-plane message, one or more channel estimation measurement metrics that are based at least in part on the transmission configuration information.

Some aspects described herein relate to an apparatus for wireless communication at an RU. The apparatus may include one or more memories and one or more processors coupled to the one or more memories. The one or more processors may be configured, individually or collectively, to cause the apparatus to receive, as at least part of a first fronthaul C-plane message, an SRS section extension that indicates transmission configuration information associated with two or more SRS port and one or more transmissions that share one or more air interface resources that span multiple symbols and one or more frequency partitions. The one or more processors may be configured, individually or collectively, to cause the apparatus to transmit, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of, multiple SRS ports, of the two or more SRS ports, in a same SRS section extensions, or multiple SRS ports that are indicated by multiple SRS section extensions. In some aspects, the multiple SRS section extensions may be associated with a respective time partition (e.g., a respective time slot).

Some aspects described herein relate to an apparatus for wireless communication at an RU. The apparatus may include one or more memories and one or more processors coupled to the one or more memories. The one or more processors may be configured, individually or collectively, to cause the apparatus to receive, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols. The one or more processors may be configured, individually or collectively, to cause the apparatus to transmit, as at least part of a second fronthaul C-plane message, one or more channel estimation measurement metrics that are based at least in part on the transmission configuration information.

Some aspects described herein relate to a non-transitory computer-readable medium that stores a set of instructions for wireless communication by an RU. The set of instructions, when executed by one or more processors of the RU, may cause the RU to receive, as at least part of a first fronthaul C-plane message, an SRS section extension that indicates transmission configuration information associated with two or more SRS ports and one or more transmissions that share one or more air interface resources that span multiple symbols and one or more frequency partitions. The set of instructions, when executed by one or more processors of the RU, may cause the RU to transmit, as at least part of a second fronthaul C-plane message, one or more channel estimation measurement metrics that are based at least in part on the transmission configuration information.

Some aspects described herein relate to a non-transitory computer-readable medium that stores a set of instructions for wireless communication by a DU. The set of instructions, when executed by one or more processors of the DU, may cause the DU to transmit, as at least part of a first fronthaul C-plane message, an SRS section extension that indicates transmission configuration information associated two or more SRS ports and one or more transmissions that share one or more air interface resources that span multiple symbols and one or more frequency partitions. The set of instructions, when executed by one or more processors of the DU, may cause the DU to receive, as at least part of a second fronthaul C-plane message, one or more channel estimation measurement metrics that are based at least in part on the transmission configuration information.

Some aspects described herein relate to a non-transitory computer-readable medium that stores a set of instructions for wireless communication by an RU. The set of instructions, when executed by one or more processors of the RU, may cause the RU to receive, as at least part of a first fronthaul C-plane message, an SRS section extension that indicates transmission configuration information associated with two or more SRS port and one or more transmissions that share one or more air interface resources that span multiple symbols and one or more frequency partitions. The set of instructions, when executed by one or more processors of the RU, may cause the RU to transmit, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of, multiple SRS ports, of the two or more SRS ports, in a same SRS section extensions, or multiple SRS ports that are indicated by multiple SRS section extensions.

Some aspects described herein relate to a non-transitory computer-readable medium that stores a set of instructions for wireless communication by an RU. The set of instructions, when executed by one or more processors of the RU, may cause the RU to receive, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols. The set of instructions, when executed by one or more processors of the RU, may cause the RU to transmit, as at least part of a second fronthaul C-plane message, one or more channel estimation measurement metrics that are based at least in part on the transmission configuration information.

Some aspects described herein relate to an apparatus for wireless communication. The apparatus may include means for receiving, as at least part of a first fronthaul C-plane message, an SRS section extension that indicates transmission configuration information associated with two or more SRS ports and one or more transmissions that share one or more air interface resources that span multiple symbols and one or more frequency partitions. The apparatus may include means for transmitting, as at least part of a second fronthaul C-plane message, one or more channel estimation measurement metrics that are based at least in part on the transmission configuration information.

Some aspects described herein relate to an apparatus for wireless communication. The apparatus may include means for transmitting, as at least part of a first fronthaul C-plane message, an SRS section extension that indicates transmission configuration information associated two or more SRS ports and one or more transmissions that share one or more air interface resources that span multiple symbols and one or more frequency partitions. The apparatus may include means for receiving, as at least part of a second fronthaul C-plane message, one or more channel estimation measurement metrics that are based at least in part on the transmission configuration information.

Some aspects described herein relate to an apparatus for wireless communication. The apparatus may include means for receiving, as at least part of a first fronthaul C-plane message, an SRS section extension that indicates transmission configuration information associated with two or more SRS port and one or more transmissions that share one or more air interface resources that span multiple symbols and one or more frequency partitions. The apparatus may include means for transmitting, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of, multiple SRS ports, of the two or more SRS ports, in a same SRS section extensions, or multiple SRS ports that are indicated by multiple SRS section extensions.

Some aspects described herein relate to an apparatus for wireless communication. The apparatus may include means for receiving, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols. The apparatus may include means for transmitting, as at least part of a second fronthaul C-plane message, one or more channel estimation measurement metrics that are based at least in part on the transmission configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of communications that may be used by one or more network nodes in an open radio access network (O-RAN), in accordance with the present disclosure.

FIG. 4 is a diagram illustrating an example of a sounding reference signal (SRS)-beamformed communication in an O-RAN, in accordance with the present disclosure.

FIG. 5 is a diagram illustrating an example of a time division duplex multiplex group, in accordance with the present disclosure.

FIG. 6 is a diagram illustrating an example SRS section extension, in accordance with the present disclosure.

FIGS. 7A and 7B are diagrams illustrating a first example SRS section extension and a second example SRS section extension, respectively, in accordance with the present disclosure.

FIG. 8 is a diagram illustrating an example of a wireless communication process between a distributed unit (DU), a radio unit (RU), and one or more user equipments, in accordance with the present disclosure.

FIG. 9 is a diagram illustrating an example process performed, for example, at an RU or an apparatus of an RU, in accordance with the present disclosure.

FIG. 10 is a diagram illustrating an example process performed, for example, at a DU or an apparatus of a DU, in accordance with the present disclosure.

FIG. 11 is a diagram illustrating an example process performed, for example, at an RU or an apparatus of an RU, in accordance with the present disclosure.

FIG. 12 is a diagram illustrating an example process performed, for example, at an RU or an apparatus of an RU, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

“Sounding reference signal (SRS)-based beamforming” refers to the use of an SRS to optimize beamforming. To illustrate, in a time division duplex (TDD) system, uplink and downlink transmissions may use a same frequency band in alternate time partitions. Accordingly, channel properties observed by a downlink transmission may also be observed by an uplink transmission (and/or vice versa), which may also be referred to as “channel reciprocity.” Based at least in part on channel reciprocity, a network node may obtain channel characteristics of a wireless channel using an uplink signal, such as an SRS, and modify transmission parameters for a downlink communication that uses the same wireless channel. Accordingly, SRS-based beamforming may include using channel information obtained via SRS to modify one or more beamforming parameters and/or transmission parameters (e.g., downlink and/or uplink) in a manner that increases data throughput, decreases data recovery errors, and/or decreases data transfer latencies. Example beamforming parameters may include beam direction, beamforming weights, a beam index, and/or a transmission power level. Example transmission parameters may include a modulation and coding scheme (MCS), a frequency band, and/or a bandwidth.

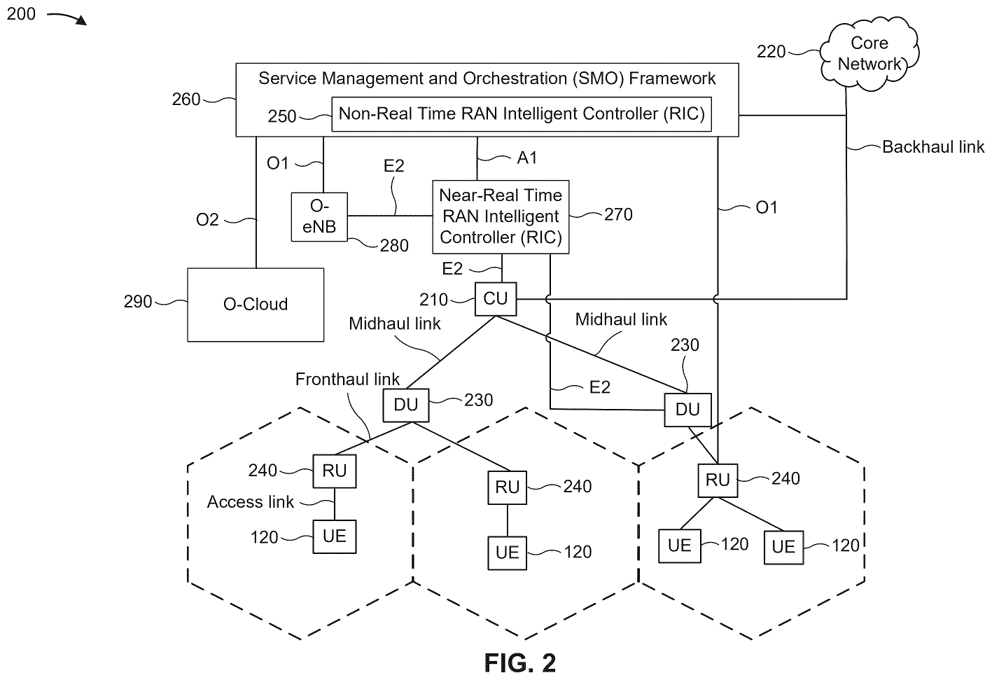

A network node in an open radio access network (O-RAN) may be a disaggregated network node (sometimes referred to as a disaggregated base station) that uses a disaggregated architecture. For instance, the network node may operate with a radio protocol stack that is physically distributed and/or logically distributed among two or more nodes in the same geographic location or in different geographic locations. An example disaggregated network node architecture is described in more detail below with reference to FIG. 2. Some example network nodes used in the disaggregated network node architecture may include a distributed unit (DU) and a radio unit (RU).

To perform SRS-based beamforming, a DU may configure one or more SRS-related parameters for SRS transmission by a user equipment (UE), and indicate the SRS-related parameters to an RU. The RU may indicate the SRS-related parameters to the UE, and the UE may transmit an SRS using the SRS-related parameters. The RU may receive the SRS and may generate one or more samples, such as by generating one or more in-phase (I) and quadrature (Q) samples of the SRS using an analog-to-digital converter (ADC). The RU may transmit a set of I/Q samples to the DU using a fronthaul link between the RU and the DU. Based at least in part on receiving the set of I/Q samples, the DU may compute a channel estimation metric and use the channel estimation metric to select a beamforming parameter and/or a transmission parameter for a downlink communication to the UE. The DU may indicate the beamforming parameter and/or the transmission parameter to the RU (e.g., using the fronthaul link), and the RU may transmit an SRS-based beamformed communication that is based at least in part on the SRS transmitted by the UE and/or an assumption of channel reciprocity between an uplink channel and a downlink channel. That is, the SRS-based beamformed communication may use the beamforming parameter and/or transmission parameter that is derived by the DU using the I/Q samples of the SRS.

In some cases, the transmission of the digital samples may increase a signaling overhead between the RU and the DU, and the increased signaling overhead may reduce network performance. For example, the increased signaling overhead may lead to an increased latency for processing and exchanging messages between the RU and the DU, reduced user data throughput, increased user data transfer latencies, and/or increased congestion in the fronthaul interface.

Various aspects relate generally to an SRS section extension for channel estimation by an RU. Some aspects more specifically relate to an RU calculating channel estimation measurement metrics using transmission configuration information from a DU. In some aspects, an RU may receive a first fronthaul control plane (C-plane) message that includes an SRS section extension, and the SRS section extension may indicate transmission configuration information that is associated with two or more SRS ports and one or more transmissions that share one or more air interface resources that span multiple symbols and one or more frequency partitions. Based at least in part on receiving the first fronthaul C-plane message, the RU may transmit a second fronthaul C-plane message that indicates one or more channel estimation measurement metrics that are based at least in part on the transmission configuration information. For example, the RU may compute the channel estimation measurement metric(s) using the transmission configuration information and/or one or more SRSs that are the one or more transmissions (e.g., instead of transmitting a set of I/Q samples to the DU).

In some aspects, a DU may transmit a first fronthaul C-plane message that indicates and/or includes an SRS section extension, and the SRS section extension may indicate transmission configuration information that is associated with two or more SRS ports and one or more transmissions that share one or more air interface resources that span multiple symbols and one or more frequency partitions. Based at least in part on transmitting the first fronthaul C-plane message, the DU may receive a second fronthaul C-plane message that includes and/or indicates one or more channel estimation measurement metrics, and the channel estimation measurement metrics may be based at least in part on the transmission configuration information in the first fronthaul C-plane message. For instance, the channel estimation measurement metrics may be from an RU that uses the transmission configuration information to compute the channel estimation measurement metrics.

Particular aspects of the subject matter described in this disclosure can be implemented to realize one or more of the following potential advantages. In some examples, by receiving a C-plane message that indicates transmission configuration information (e.g., associated with multiple UEs that share one or more air interface resources in a time partition and a frequency partition to transmit respective SRSs), the described techniques can be used to enable an RU to compute an accurate channel estimation measurement metric (e.g., a channel estimation measurement metric that satisfies an accuracy threshold) and reduce signaling overhead. To illustrate, instead of transmitting SRS I/Q samples on the fronthaul interface for DU to derive channel estimates the RU may derive channel estimates within the RU, reducing the signaling overhead. The RU may alternatively or additionally derive downlink and/or uplink beamforming parameters (e.g., beamforming weight) and/or transmission parameters instead of transmitting the channel estimates to the RU and receiving the beamforming parameters from the DU, thus further reducing a signaling overhead on fronthaul load. Reducing a signaling overhead may result in a reduced latency for processing and exchanging messages between an RU and a DU, increase user data throughput, decrease user data transfer latencies, and/or decrease congestion in the fronthaul interface.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

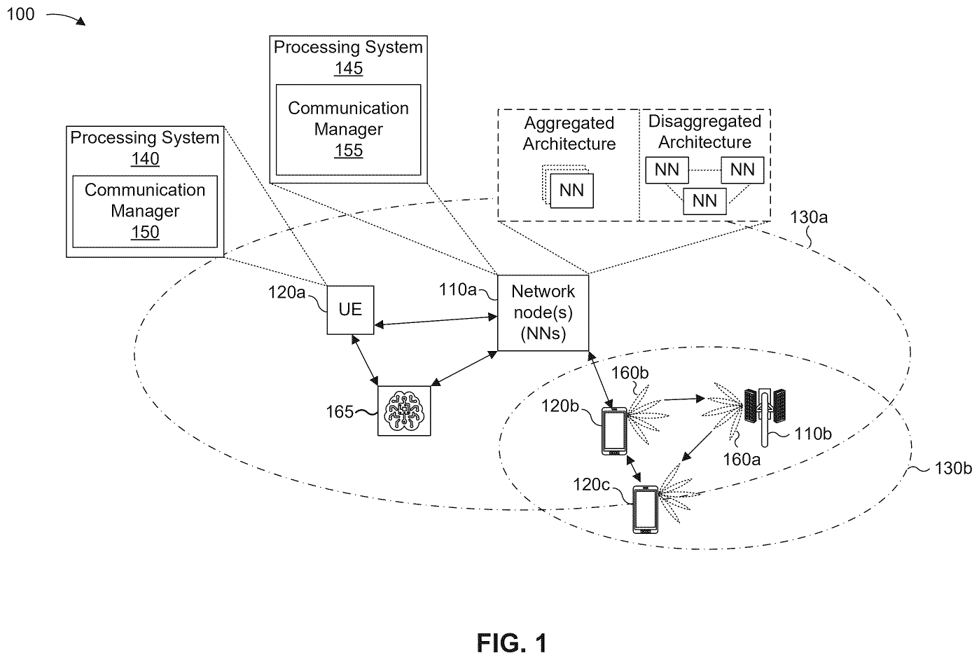

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an O-RAN (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters.

Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, an RU (e.g., a network node 110 and/or an RU 240) may include a communication manager 155. As described in more detail elsewhere herein, the communication manager 155 may receive, as at least part of a first fronthaul C-plane message, an SRS section extension that indicates transmission configuration information associated with two or more SRS ports and one or more transmissions that share one or more air interface resources that span multiple symbols and one or more frequency partitions; and transmit, as at least part of a second fronthaul C-plane message, one or more channel estimation measurement metrics that are based at least in part on the transmission configuration information.

Alternatively, or additionally, the communication manager 155 may receive, as at least part of a first fronthaul C-plane message, an SRS section extension that indicates transmission configuration information associated with two or more SRS port and one or more transmissions that share one or more air interface resources that span multiple symbols and one or more frequency partitions; and transmit, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of: multiple SRS ports, of the two or more SRS ports, in a same SRS section extensions, or multiple SRS ports that are indicated by multiple SRS section extensions. In some aspects, the multiple SRS section extensions may be associated with a respective time partition (e.g., a respective time slot).

Alternatively, or additionally, the communication manager 155 may receive, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols; and transmit, as at least part of a second fronthaul C-plane message, one or more channel estimation measurement metrics that are based at least in part on the transmission configuration information. Additionally, or alternatively, the communication manager 155 may perform one or more other operations described herein.

In some aspects, a DU (e.g., a network node 110 and/or a DU 230) may include a communication manager 155. As described in more detail elsewhere herein, the communication manager 155 may transmit, as at least part of a first fronthaul C-plane message, an SRS section extension that indicates transmission configuration information associated two or more SRS ports and one or more transmissions that share one or more air interface resources that span multiple symbols and one or more frequency partitions; and receive, as at least part of a second fronthaul C-plane message, one or more channel estimation measurement metrics that are based at least in part on the transmission configuration information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

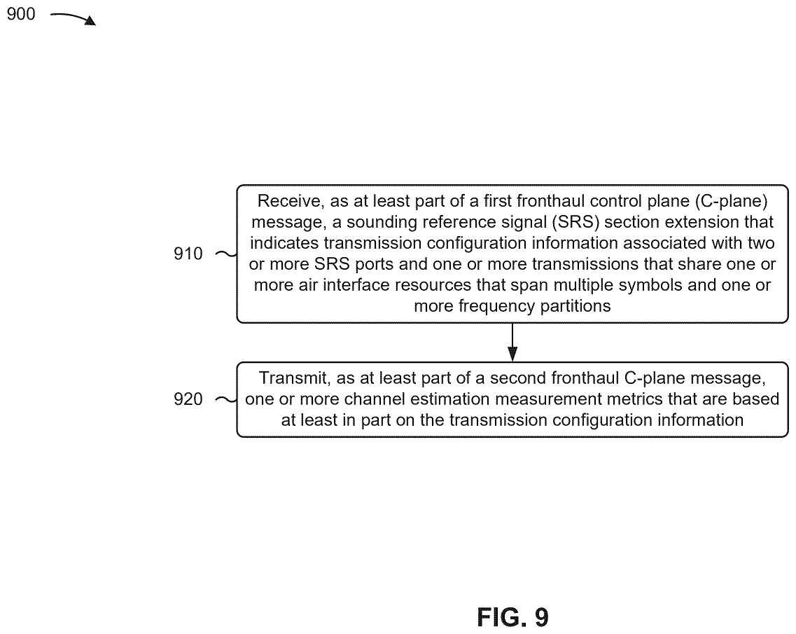

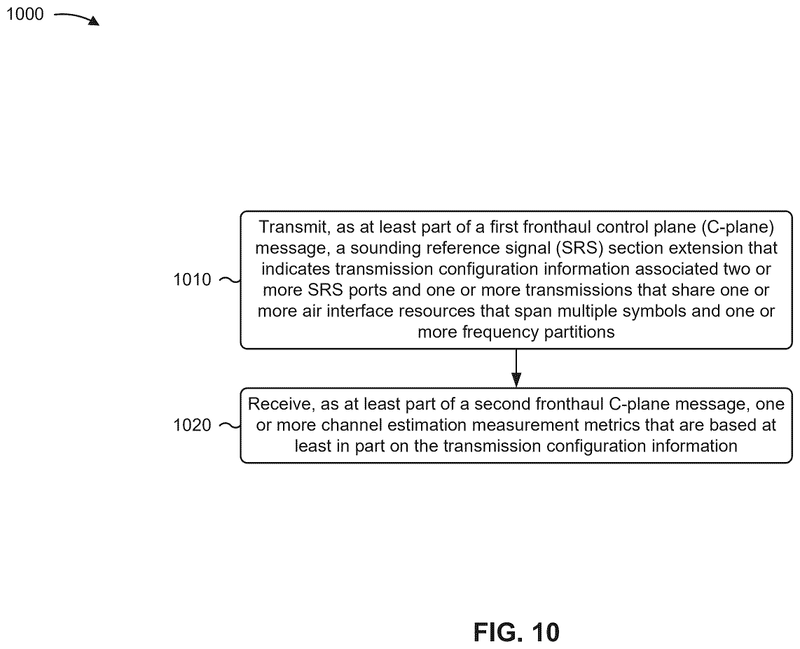

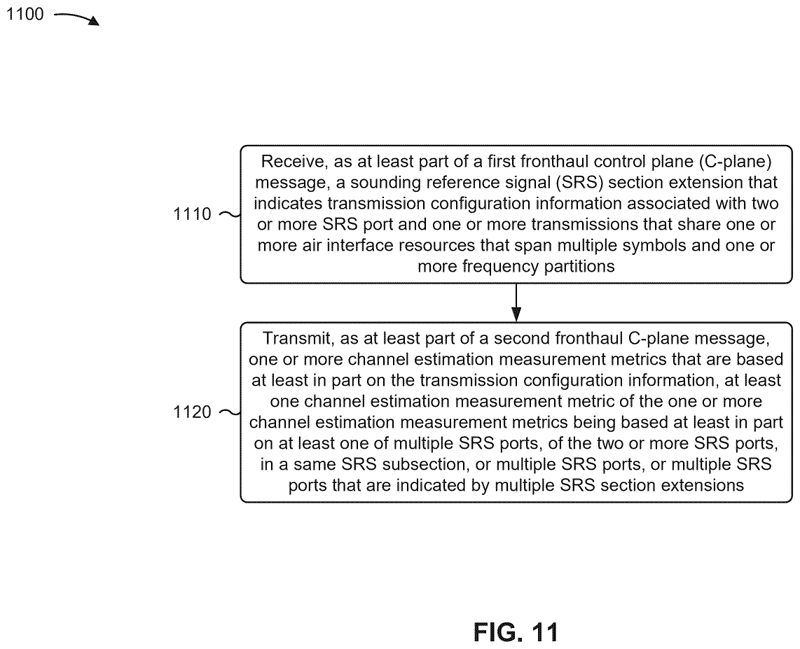

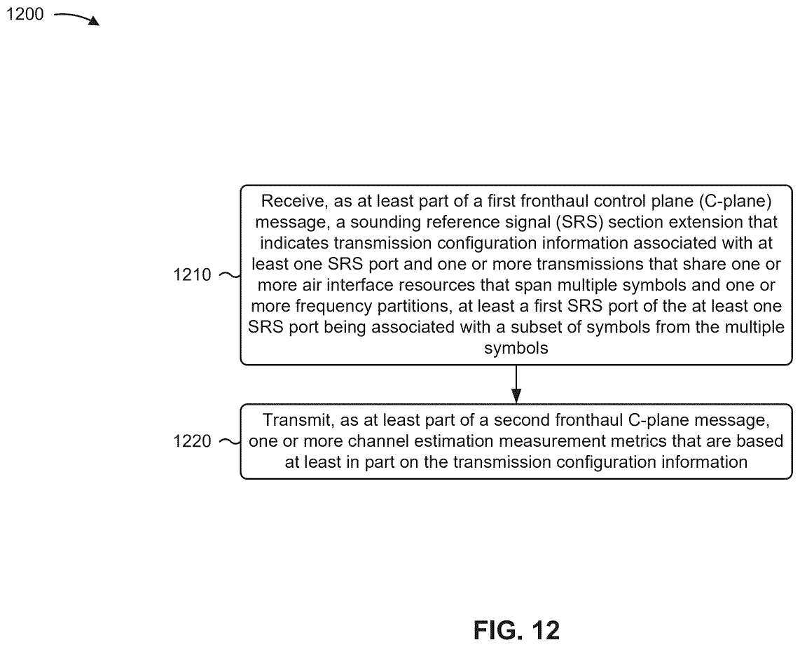

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with an SRS section extension for channel estimation by an RU, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context.

Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, an RU (e.g., a network node 110 and/or an RU 240) includes means for receiving, as at least part of a first fronthaul C-plane message, an SRS section extension that indicates transmission configuration information associated with two or more SRS ports and one or more transmissions that share one or more air interface resources that span multiple symbols and one or more frequency partitions; and/or means for transmitting, as at least part of a second fronthaul C-plane message, one or more channel estimation measurement metrics that are based at least in part on the transmission configuration information.

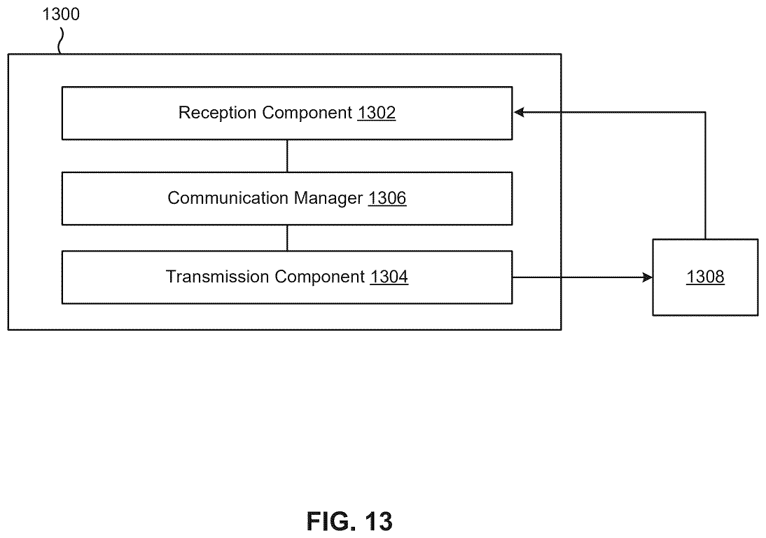

Alternatively, or additionally, the RU includes means for receiving, as at least part of a first fronthaul C-plane message, an SRS section extension that indicates transmission configuration information associated with two or more SRS port and one or more transmissions that share one or more air interface resources that span multiple symbols and one or more frequency partitions; and/or means for transmitting, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of: multiple SRS ports, of the two or more SRS ports, in a same SRS section extensions, or multiple SRS ports that are indicated by multiple SRS section extensions Alternatively, or additionally, the RU includes means for receiving, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols; and/or means for transmitting, as at least part of a second fronthaul C-plane message, one or more channel estimation measurement metrics that are based at least in part on the transmission configuration information. In some aspects, the means for the RU to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

In some aspects, a DU (e.g., a network node 110 and/or a DU 230) includes means for transmitting, as at least part of a first fronthaul C-plane message, an SRS section extension that indicates transmission configuration information associated two or more SRS ports and one or more transmissions that share one or more air interface resources that span multiple symbols and one or more frequency partitions; and/or means for receiving, as at least part of a second fronthaul C-plane message, one or more channel estimation measurement metrics that are based at least in part on the transmission configuration information. In some aspects, the means for the DU to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

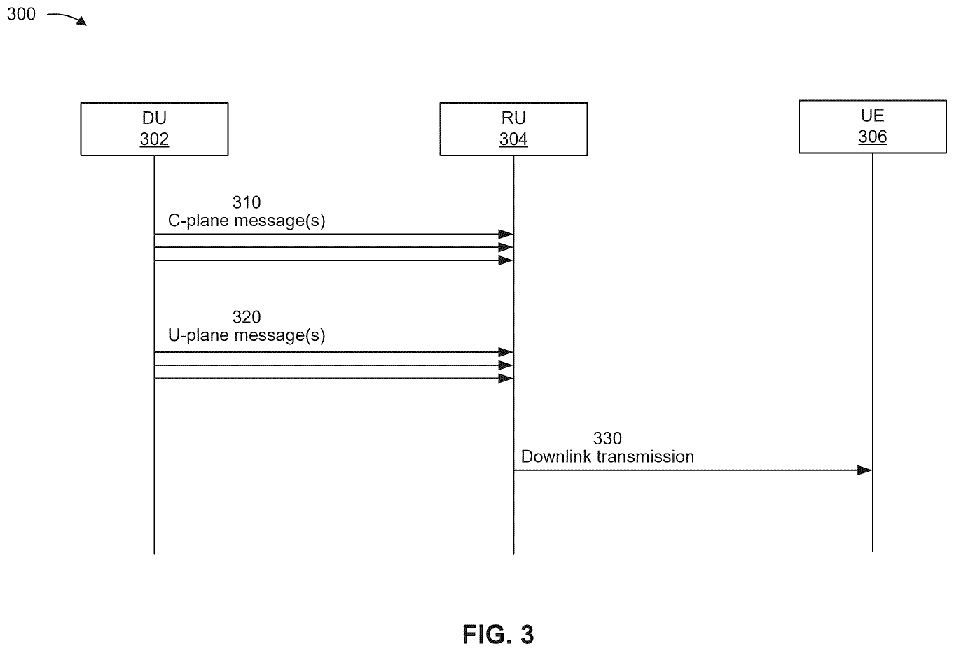

FIG. 3 is a diagram illustrating an example 300 of communications that may be used by one or more network nodes in an O-RAN, in accordance with the present disclosure.

As described with regard to FIG. 2, the components and/or network nodes of a disaggregated base station used in an O-RAN may communicate with one another using a variety of messages to provide service to a UE via an access link. Some example messages may include service plane (S-Plane) messages, management plane (M-Plane) messages, C-Plane messages, and/or user plane (U-Plane) messages. The various messages may be communicated between the components and/or network nodes using one or more wired links and/or one or more wireless links.

S-Plane messages may be used to provide services to a UE, such as call setup services and/or mobility management services. Non-limiting examples of S-plane messages include service provisioning messages, service management messages, and/or service control messages.

M-plane messages may be used to manage various network elements (e.g., components and/or network nodes in the O-RAN), network resources, and/or network operation. To illustrate, M-Plane messages may be used to manage a network configuration, network fault detection, network performance management, and/or network security management. Some non-limiting examples of M-Plane messages may include network element configuration messages, performance queries, performance responses, and fault detection messages.

C-Plane messages may be used to manage and/or control access to the network, such as management and/or control of an access link. For instance, C-Plane messages may be used to establish and/or maintain an access link with a UE. Some non-limiting example C-Plane messages may include resource allocation messages (e.g., for establishing and/or communicating via the access link), mobility management messages, and configuration messages.

U-Plane messages may be used to manage and/or control user data traffic transmitted and/or received via an access link. Some non-limiting example U-Plane messages may include data packet messages, user data frames, segmentation and/or reassembly messages, and/or payload data. In some aspects, U-Plane messages may include information for particular types of DCI that may be carried by a data traffic transmission, such as scheduling DCI, power control DCI, and/or channel quality indicator (CQI) DCI. In other aspects, DCI may be configured via C-Plane messages (e.g., without the use of U-Plane messages).

The example 300 shown by FIG. 3 is an example of communications that may occur between a DU 302 (e.g., a DU 230 and/or a first network node 110) and an RU 304 (e.g., an RU 240 and/or a second network node 110) to generate a downlink data transmission to a UE 306 (e.g., a UE 120) via an access link. As shown by reference number 310, the DU 302 may communicate, and the RU 304 may receive, one or more C-Plane messages. As described above, the DU 302 and the RU 304 may communicate with one another via a wireless communication link and/or a wired communication link, such as a fronthaul link as described with regard to FIG. 2. In some aspects, the C-Plane messages may indicate, to the RU 304, any combination of a resource allocation, an MCS, beamforming instructions, and/or a power control configuration to use for the downlink data transmission.

As shown by reference number 320, the DU 302 may communicate, and the RU 304 may receive, one or more U-plane messages. As one example, the DU 302 may communicate the UE-plane messages via the fronthaul link, and the U-Plane message(s) may include payload data and/or data packet(s) to include in the downlink data transmission.

As shown by reference number 330, the RU 304 may transmit, and the UE 306 may receive, a downlink transmission. In some aspects, the RU 304 may generate the downlink transmission using configuration information indicated by the C-plane message(s), such as resource allocation configuration information (e.g., a frequency band and/or a time resource), a power level, a beamforming and/or antenna configuration, CQI reporting configuration, and/or a scheduling configuration. While the example 300 shown by FIG. 3 includes an example of a C-Plane message being used to configure a downlink data transmission, other examples may include a C-Plane message being used to configure a downlink control message, an uplink data traffic message, and/or an uplink control message. Some non-limiting examples may include DCI, scheduling messages (e.g., timing, frequency, and/or duration information), system information broadcasts, paging messages, and/or acknowledgment/negative acknowledgement (ACK/NACK) messages.

While FIG. 3 illustrates an example of the DU 302 communicating with the RU 304 to transmit a downlink communication to a UE, similar messaging may be used to configure how the UE 306 transmits an uplink communication. For instance, the DU 302 may schedule uplink resources for the UE 306, and indicate the uplink allocation in a C-plane message to the RU 304. Based at least in part on receiving the uplink allocation C-plane message, the RU 304 may transmit DCI that indicates the uplink allocation to the UE 306.

A C-Plane message may indicate the configuration information using a variety of formats. To illustrate, a C-Plane message may include a header section that provides information about a message type carried by the C-Plane message, a message length of the C-Plane message, a source identifier (ID), a destination ID, and/or a protocol version. Alternatively, or additionally, the C-Plane message may include a payload (e.g., the configuration information), and the format and/or information of the payload may vary based at least in part on a message type of the C-Plane message. For instance, the payload of a configuration message type may indicate configuration information that instructs a network node (e.g., an RU) regarding what configuration to use for transmitting and/or receiving a signal (e.g., resource allocation parameter(s), an MCS, a power control setting, a beamforming configuration, and/or an antenna configuration), while the payload of a mobility management message type may indicate UE mobility parameters (e.g., handover parameters, a measurement report from a UE, and/or mobility control commands).

In some aspects, a C-Plane message may include one or more sections, and each section may indicate information about a respective group of resources and/or a respective resource allocation. Alternatively, or additionally, each resource allocation may be based at least in part on time domain partitioning and/or frequency domain partitioning through the use of any combination of symbols, resource blocks (RBs), resource block groups (RBGs), and/or physical resource blocks (PRBs). In some aspects, an RB may include multiple contiguous PRBs, and an RBG may include multiple contiguous RBs. Accordingly, in order from smallest to largest, a PRB is included in an RB, and an RB is included in an RBG.

Information in a C-Plane message that describes one or more characteristics about a resource allocation may alternatively be referred to as a “section description” and/or a “section structure,” and a C-Plane message may include different types of section descriptions and/or different types of section structures to indicate different information about different section types. For instance, a C-Plane message may include a Section Type 0 structure that indicates information about idle and/or guard periods, a Section Type 1 structure that indicates information about downlink and/or uplink radio channels, a Section Type 3 structure that indicates information about a physical random access channel (PRACH), a Section Type 5 structure that indicates information about UE scheduling, a Section Type 6 structure that indicates channel information directed to a specific UE identifier (ID), and/or a Section Type 7 structure that indicates information about licensed assisted access (LAA). Example information that may be include in a Section Type structure may include a starting symbol identifier (startSymbolId) field, a number of symbols (numSymbol) field, a starting physical resource block (startPrb) field, and a number of PRBs (numPrb) field. In some aspects, the startSymbolId field may indicate a starting symbol for an SRS resource within a given slot, such as by indicating an index value of the starting symbol (e.g., I₀). The numSymbol field may indicate a length and/or duration of consecutive symbols that an SRS resource spans (e.g., N^{srs}_{sym}). The startPrb field may indicate a starting PRB (e.g., an index of the starting PRB) of an SRS sampling bandwidth, and the numPrb field may indicate a total number of PRBs in each SRS hop and/or may be common for all PRBs across the symbols of a given UE.

As indicated above, FIG. 3 is provided as an example. Other examples may differ from what is described with regard to FIG. 3.

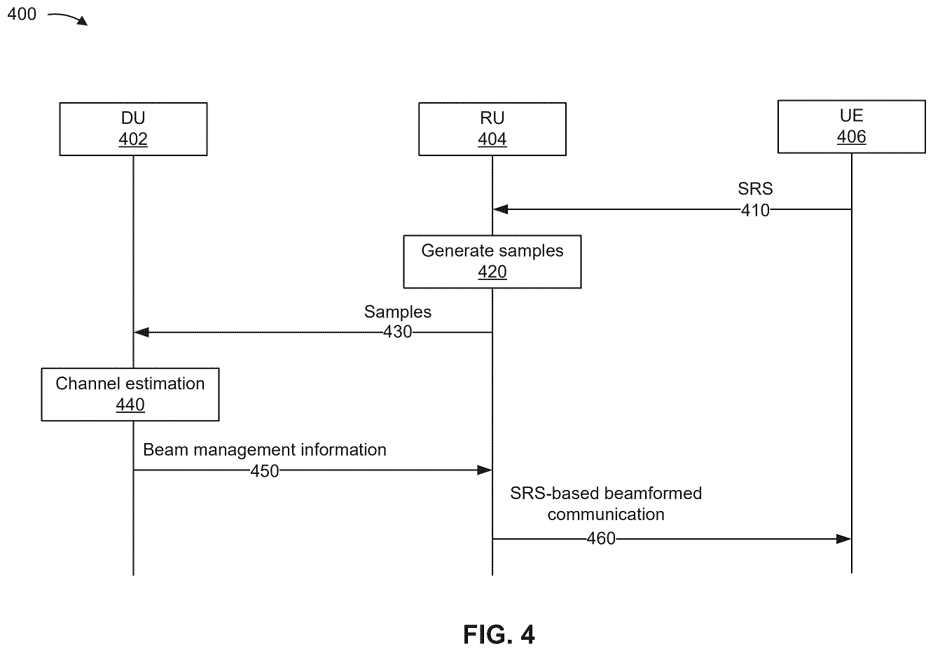

FIG. 4 is a diagram illustrating an example 400 of an SRS-beamformed communication in an O-RAN, in accordance with the present disclosure. The example 400 includes a DU 402 (e.g., a DU 230 and/or a first network node 110), an RU 404 (e.g., an RU 240 and/or a second network node 110), and a UE 406 (e.g., a UE 120). For clarity, signaling transactions are shown by FIG. 4 through the use of a single line, but may include multiple signaling transactions and/or multiple transmissions.

“SRS-based beamforming” refers to the use of an SRS to optimize beamforming. To illustrate, in a time division duplex (TDD) system, uplink and downlink transmissions may use a same frequency band in alternate time partitions. Accordingly, channel properties observed by a downlink transmission may also be observed by an uplink transmission (and/or vice versa), which may also be referred to as “channel reciprocity”. Based at least in part on channel reciprocity, a network node may obtain channel characteristics of a wireless channel (e.g., CSI) using an uplink signal, such as an SRS, and modify transmission parameters for a downlink communication that uses the same wireless channel. Accordingly, SRS-based beamforming may include using channel information obtained vian SRS to modify one or more beamforming parameters and/or transmission parameters (e.g., for downlink and/or uplink) in a manner that increases data throughput, decreases data recovery errors, and/or decreases data transfer latencies. Example beamforming parameters may include beam direction, beamforming weights, a beam index, and/or a transmission power level. Example transmission parameters may include an MCS, a frequency band, and/or a bandwidth.

To illustrate, as shown by reference number 410, a UE 406 may transmit, and an RU 404 may receive, an SRS. In some aspects, the DU 402 and the RU 404 may collectively configure the UE 406 to transmit the SRS. As one example, the DU 402 may transmit, via a fronthaul link and using C-Plane messages, SRS control information that configures one or more SRS-related parameters at the RU 404, such as an SRS periodicity, an SRS bandwidth, and/or SRS antenna ports. Alternatively, or additionally, the DU 402 may transmit, via the fronthaul link and using C-Plane messages, SRS scheduling information, such as time partition scheduling information (e.g., slot-level scheduling), sub-carrier spacing, and/or frequency resources. In turn, the RU 404 may transmit, and the UE 406 may receive, SRS scheduling information and/or resource allocation information for transmission of the SRS.

In some aspects, the RU 404 may act as a pass-through for the SRS control information. For instance, the SRS control information may be carried in RRC signaling. The RU 404 may transmit physical signals that carry the RRC signaling without using an RRC protocol layer to process the RRC signaling. Accordingly, the UE 406 transmitting the SRS as shown by reference number 410 may be based at least in part on scheduling by at least the DU 402 and the RU 404, but may include other network entities described with regard to FIG. 2.

As shown by reference number 420, the RU 404 may generate one or more samples of the SRS. For instance, the RU 404 may include an ADC that generates I/Q samples of the SRS. Accordingly, as shown by reference number 430, the RU 404 may transmit, and the DU 402 may receive one or more samples of the SRS. That is, the RU 404 may transmit a set of I/Q samples to the DU 402, such as by transmitting the samples using the fronthaul link and/or using a C-plane message.

As shown by reference number 440, the DU 402 may compute one or more channel estimation metrics using the samples. To illustrate, the DU 402 may include information related to SRS transmission by the UE 406 that is unavailable to the RU 404, and the information may enable the DU 402 to compute accurate CSI (e.g., CSI that satisfies an accuracy threshold). Example information may include SRS periodicity, SRS bandwidth configuration, SRS frequency hopping configuration, and/or an antenna port configuration, and example CSI may include any combination of CQI, PMI, CRI, SSBRI, LI, and/or RI. In some aspects, the CSI may be used by the DU 402 to select beamforming parameter(s) and/or other transmission parameters, examples of which are provided above. In other aspects, the DU 402 may forward the CSI to the RU 404 as described with regard to reference number 450 below.

Accordingly, as shown by reference number 450, the DU 402 may transmit, and the RU 404 may receive, beam management information. The beam management may, in some cases, include the CSI computed by the DU 402, and the RU 404 may derive beamforming weights and/or other transmission parameters from the CSI. Alternatively, or additionally, the beam management information may include beamforming parameter(s) and/or other transmission parameter(s) that are derived by the DU 402.

As shown by reference number 460, the RU 404 may transmit, and the UE 406 may receive, an SRS-based beamformed communication. The SRS-based beamformed communication may be transmitted by the RU 404 using the beam management information from the DU 402. That is, the communication transmitted by the RU 404 may be based at least in part on the SRS transmitted by the UE 406 and/or an assumption of channel reciprocity between an uplink channel and a downlink channel.

In the example 400, the RU 404 generates digital samples of the SRS transmitted by the UE 406 and transmits the digital samples to the DU 402, and the DU 402 uses the digital samples to compute channel estimation metric(s) and/or to derive the beam management information as described with regard to reference number 440 and reference number 450, respectively. In some cases, the transmission of the digital samples may increase a signaling overhead between the RU 404 and the DU 402, and the increased signaling overhead may reduce network performance. For example, the increased signaling overhead may lead to an increased latency for processing and exchanging messages between the RU 404 and the DU 402, reduced user data throughput, increased user data transfer latencies, and/or increased congestion in the fronthaul load.

Various aspects relate generally to an SRS section extension for channel estimation by an RU. Some aspects more specifically relate to an RU calculating channel estimation measurement metrics using transmission configuration information from a DU. In some aspects, an RU may receive a first fronthaul C-plane message that includes an SRS section extension, and the SRS section extension may indicate transmission configuration information that is associated with two or more SRS ports and one or more transmissions that share one or more air interface resources that span multiple symbols and one or more frequency partitions. As an example, the SRS section extension may indicate the transmission configuration information using a numTddMuxGroup field (e.g., in a common parameter subsection of the SRS section extension) that indicates a number of TDD multiplex groups that are associated with the one or more SRS ports, a tddMuxGrp field (e.g., in a port-specific parameter subsection of the SRS section extension) that indicates a TDD multiplex group that is associated with a particular SRS port of the SRS port(s), and/or a SymbolTddMuxGrp field (e.g., in a symbol-specific parameter subsection of the SRS section extension) that indicates a TDD multiplex group that is associated with a particular symbol of multiple symbols.

In some cases, the SymbolTddMuxGrp field may be associated with a particular SRS port. Alternatively, or additionally, the SRS section extension may indicate the transmission configuration information using a numSampledUeId field (e.g., in a common parameter subsection of the SRS section extension) that indicates a total number of sounded SRS antenna ports for the multiple UEs and/or an srsSymbBitMap field (e.g., in a per-port information segment of the SRS section extension) that indicates a symbol bit map that maps each respective bit to a respective symbol index of a respective symbol of multiple symbols (e.g., that are associated with a particular SRS port of the multiple SRS ports). Based at least in part on receiving the first fronthaul C-plane message, the RU may transmit a second fronthaul C-plane message that indicates one or more channel estimation measurement metrics that are based at least in part on the transmission configuration information. For example, the RU may compute the channel estimation measurement metric(s) using the transmission configuration information and/or one or more SRSs that are the one or more transmissions.

In some aspects, a DU may transmit a first fronthaul C-plane message that indicates and/or includes an SRS section extension, and the SRS section extension may indicate transmission configuration information that is associated with two or more SRS ports and one or more transmissions that share one or more air interface resources that span multiple symbols and one or more frequency partitions. The SRS section extension may indicate the transmission configuration information using any combination of a numTddMuxGroup field, a tddMuxGrp field, a SymbolTddMuxGrp field, a numSampledUeId field and/or an srsSymbBitMap field as described above. Based at least in part on transmitting the first fronthaul C-plane message, the DU may receive a second fronthaul C-plane message that includes and/or indicates one or more channel estimation measurement metrics, and the channel estimation measurement metrics may be based at least in part on the transmission configuration information in the first fronthaul C-plane message. For instance, the channel estimation measurement metrics may be from an RU that uses the transmission configuration information to compute the channel estimation measurement metrics.

Particular aspects of the subject matter described in this disclosure can be implemented to realize one or more of the following potential advantages. In some examples, by receiving a C-plane message that indicates transmission configuration information (e.g., associated with multiple UEs that share one or more air interface resources in a time partition and a frequency partition to transmit respective SRSs), the described techniques can be used to enable an RU to compute accurate CSI (e.g., CSI that satisfies an accuracy threshold) and reduce signaling overhead. To illustrate, instead of transmitting SRS I/Q samples on the fronthaul interface for the DU to use to derive channel estimates, the RU may derive channel estimates locally using the SRS I/Q samples (e.g., and not transmitting the I/Q samples to the UE), reducing the signaling overhead. The RU may alternatively or additionally derive downlink and/or uplink beamforming parameters (e.g., beamforming weights) and/or transmission parameters instead of transmitting the channel estimates to the RU and receiving the beamforming parameters from the DU, thus further reducing a signaling overhead on fronthaul load. Reducing a signaling overhead may result in a reduced latency for processing and exchanging messages between an RU (e.g., the RU 404) and a DU (e.g., the DU 402), increase user data throughput, decrease user data transfer latencies, and/or decrease congestion in the fronthaul load.

As indicated above, FIG. 4 is provided as an example. Other examples may differ from what is described with regard to FIG. 4.

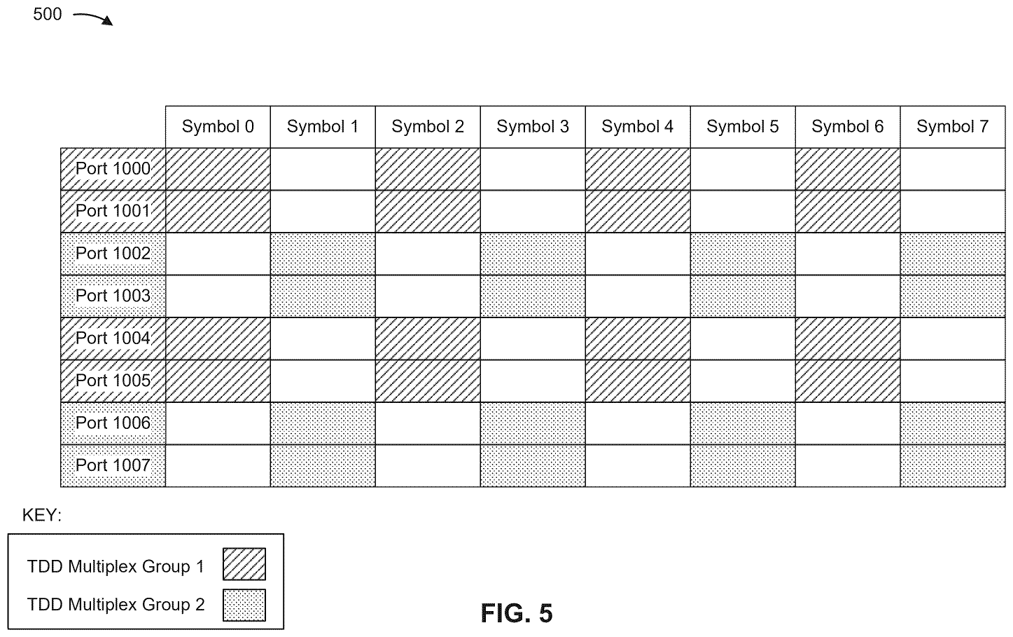

FIG. 5 is a diagram illustrating an example 500 of a TDD multiplex group, in accordance with the present disclosure.

TDD multiplex groups provide a mechanism to manage SRS transmission from multiple antenna ports and/or multiple UEs. TDD may be used enable the SRS transmissions to use a same frequency partition in different time partitions and mitigate the multiple transmissions interfering with one another. For instance, a network node (e.g., a DU) may configure the TDD multiplex groups used by one or more UEs to transmit SRS and/or time partitions that are assigned to the TDD multiplex groups. In some aspects, TDD multiplex grouping may be based at least in part on an antenna port used to transmit an SRS (e.g., an SRS port) and/or a time partition (e.g., a symbol).

The example 500 includes a mapping between symbol-based time partitions and antenna ports. Each column of the mapping is associated with a respective symbol (shown as Symbol 0, Symbol 1, up to Symbol 7), and each row of the mapping is associated with a respective SRS port (shown as Port 1000, Port 1001, up to Port 1007). In the example 500, a network node may assign two TDD multiplex groups to the set of SRS ports based at least in part on the set of symbol-based time partitions, but in other examples, the network node may assign more than two TDD multiplex groups to a set of SRS ports

As shown by FIG. 5, Port 1000, Port 1001, Port 1004, and Port 1005 are assigned to a first TDD multiplex group (shown through the use of a diagonal striped pattern), and Port 1002, Port 1003, Port 1006, and Port 1007 are assigned to a second TDD multiplex group. The first TDD multiplex group (e.g., TDD multiplex group 1) are assigned a first grouping of symbol-based time partitions, and the second TDD multiplex group (e.g., TDD multiplex group 2) are assigned a second grouping of symbol-based time partitions that are different from the first grouping. For instance, the first TDD multiplex group is assigned Symbol 0, Symbol 2, Symbol 4, and Symbol 6, and the second TDD multiplex group is assigned Symbol 1, Symbol 3, Symbol 45, and Symbol 7. Accordingly, a UE may transmit via Port 1000, Port 1001, Port 1004, and/or Port 1005 in the assigned time partitions associated with the first TDD multiplex group (shown with a diagonal stripped pattern), and/or the UE may transmit via Port 1002, Port 1003, Port 1006, and/or Port 1007 in the assigned time partitions associated with the second TDD multiplex group (shown with a dotted pattern). Alternatively, or additionally, the UE does not transmit via the SRS ports assigned to the first TDD multiplex group during the symbol-based time partitions associated with the second TDD multiplex group or vice versa (shown in solid white).

As indicated above, FIG. 5 is provided as an example. Other examples may differ from what is described with regard to FIG. 5.

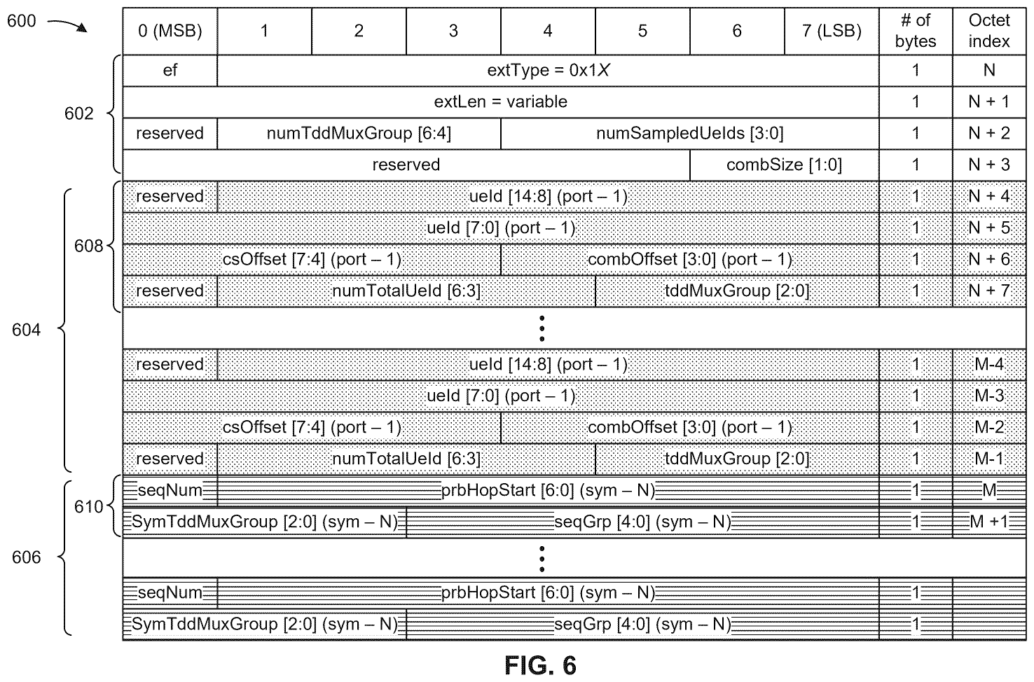

FIG. 6 is a diagram illustrating an example SRS section extension 600, in accordance with the present disclosure.

The SRS section extension 600 is an example section extension that may be included in a C-Plane message to provide transmission configuration information for multiple SRS ports that are associated with multiple UEs that share one or more air interface resources in a time partition and a frequency partition (e.g., to transmit a respective SRS using one or more SRS ports of the multiple SRS ports). The SRS section extension 600 may be considered additional information and/or supplemental information to Section Type information. To illustrate, information included in the SRS section extension 600 may be used in combination with information included in a Section Type 1 structure, a Section Type 3 structure, and/or a Section Type 5 structure.

The SRS section extension 600 shown by FIG. 6 is partitioned into multiple rows, and each row includes eight (8) bits that are ordered from the most significant bit (MSB) (e.g., bit 0) to the least significant bit (LSB) (e.g., bit 7). As shown by FIG. 6, the SRS section extension 600 may be partitioned into one or more subsections that include one or more rows of the SRS section extension 600, such as a common parameter subsection 602 (shown in solid white) that indicates a first set of common parameters that are common to each SRS port of the multiple SRS ports, a port-specific parameter subsection 604 (shown with a dotted pattern) that indicates a second set of port-specific parameters that indicate port configuration information for each SRS ports of the multiple SRS ports and an entirety of symbols used by the multiple SRS ports, and a symbol-specific parameter subsection 606 (shown with a horizontal stripe pattern) that indicates a third set of symbol-specific parameters that indicate symbol configuration information for each symbol of the entirety of symbols used by the one or more SRS ports. The port-specific parameter subsection 604 may indicate the second set of per-port parameters using one or more per-port information segments 608, and the symbol-specific parameter subsection 606 may indicate the third set of symbol-specific parameter using one or more per-symbol information segments 610.

The SRS section extension 600 may have a variable length based at least in part on a number of SRS ports, a number of symbols (e.g., SRS symbols), and/or a number of UEs that are associated with the information included in the SRS section extension 600. To illustrate, the port-specific parameter subsection 604 may include multiple iterations of the per-port information segments 608, and/or the symbol-specific parameter subsection 606 may include multiple iterations of the per-symbol information segments 610 as described above. The per-port information segment 608 shown by FIG. 6 is based at least in part on four rows of the SRS section extension 600, and the information in a particular instance of per-port information segment 608 may be specific to a particular SRS port of the multiple SRS ports (e.g., but common to all symbols associated with the particular SRS port). Accordingly, the SRS section extension 600 may include a respective per-port information segments 608 (e.g., the four rows of information) for each SRS port of the multiple SRS ports. Alternatively, or additionally, the per-symbol information segment 610 shown by FIG. 6 includes two (2) rows of the SRS section, and the information in the per-symbol information section 610 may be specific to a particular symbol of multiple symbols associated with a particular SRS port.

The common parameter subsection 602 includes information that may be common to all of the SRS ports of any given UE in the multiple UEs. That is, information included in the common parameter subsection 602 may be common and/or applicable to every UE of the multiple UEs associated with the SRS section extension 600 and, consequently, every SRS port of each UE of the multiple UEs (e.g., the multiple SRS ports).

Bit 0 of the first row (e.g., row N) is configured as an extension flag (ef) that may be set to a first value (e.g., “0”) to indicate that no other extension for a Section Type structure is included in the C-Plane message, and a second value (e.g., “1”) to indicate that another extension for the Section Type structure is included after the SRS section extension 600. Bits 1-7 of the first row are configured as an extension type (extType) field that indicates the extension type and/or format of the information included in the extension information, shown by FIG. 6 as being set to an arbitrary value of 0×1X that may be represented using bits 1-7.

Bits 0-7 of the second row (e.g., row N+1) are configured as an extension length (extLen) field that provides a length of the extension in terms of 32-bit and/or 4-byte words. Based at least in part on the SRS section extension 600 having a variable length, the extLen field is shown by FIG. 6 has having a variable length.

Bit 0 of the third row (e.g., row N+2) is configured a reserved bit. In some aspects, a reserved bit may be a placeholder bit with no specific assigned value and/or does not indicate intentional information. A reserved bit may be a placeholder bit for a future assignment.

Bits 1-3 of the third row are configured as a numTddMuxGroup field. In some aspects, the numTddMuxGroup field indicates a number of TDD multiplex groups for the SRS ports; and the SRS ports may pertain to one a given UE, or multiple given UEs (e.g., each UE of the multiple UEs associated with the SRS section extension 600). In some cases, an RU may have an operating condition that only SRS ports of one UE be signaled in an SRS section extension 600. In other cases, SRS ports of multiple UEs may be signaled in the SRS section extension 600. SRS port inclusion (and/or SRS port exclusion) may apply to all SRS sections, or to SRS sections for particular report types.

Bits 4-7 of the third row are configured as a numSampledUeIds field. In some aspects, the numSampledUeIds field indicates a total number of sounded SRS antenna ports (e.g., antenna ports used to transmit one or more SRSs) for all of the UEs specified in an SRS section extension (e.g., the SRS section extension 600).

Bits 0-5 of the fourth row (e.g., row N+3) are configured as reserved bits. That is, the reserved bits may be placeholder bits for a future assignment.

Bits 6-7 of the fourth row are configured as a combSize field. The combSize field may indicate a transmission comb size (e.g., K_{TC}). For instance, the combSize field may indicate values specified by a communication, such as a first value (e.g., “0”) that indicates a comb size of 2, a second value (e.g., “1”) that indicates a comb size of four (4), and/or a third value (e.g., “2”) that indicates a comb size of eight (8).

As described above, the port-specific parameter subsection 604 may include multiple iterations of the per-port information segment 608. As shown by FIG. 6, the first row of the per-port information segment 608 is equivalent to row N+4 of the SRS section extension 600, the second row of the per-port information segment 608 is equivalent to row N+5 of the SRS section extension 600, the third row of the per-port information segment 608 is equivalent to row N+6 of the SRS section extension 600, and the fourth row of the per-port information segment 608 is equivalent to row N+7 of the SRS section extension 600.

Bit 0 of the first row of the per-port information segment 608 (e.g., row N+4) is configured as a reserved bit. In a similar manner as described above, the reserved bit may be a placeholder bit for a future assignment.

Bits 1-7 of the first row of the per-port information segment 608 are configured as a first portion of a UeId field, and bits 0-7 of the second row of the per-port information segment 608 (e.g., row N+5) are configured as a second portion of the UeId field. For example, the first portion may represent bits 14-8 of the UeId field and the second portion may represent bits 7-0 of the UeId field. In some aspects, the UeId field may indicate a UE ID value, and the LSBs of the UE ID value may be configured LSBs that indicate one or more SRS ports (e.g. an SRS port number used by a UE). In an alternative signaling, a list of UeIds may be deducted from an initial ueId field (e.g. a startSampledUeId field in a section extension) and a numSampledUeIds field (e.g., in the common parameters subsection) as the consecutive SRS port identifiers. For instance, the list of ueIDs may derived as a startSampledUeId value to the startSampledUeId value+(a numSampledUeIds value−1), where the startSampledUeId value is indicated by the startSampledUeId field and the numSampledUeIds value is indicated by the numSampledUeIds field. Bits 0-3 of the third row of the per-port information segment 608 (e.g., row N+6) are configured as a csOffset field. In some aspects, the csOffset field may indicate a cyclic shift that is applied per-SRS port within an SRS resource.

Bits 4-7 of the third row of the per-port information segment 608 are configured as a combOffset field. In some aspects, the combOffset field may indicate a transmission comb offset (e.g., k⁻_{TC}). The offset indicated by the combOffset field may be associated with the combSize field. To illustrate, for a comb size of 0, the combOffset field may indicate an integer within the range 0-1, for a comb size of 1, the combOffset field may indicate an integer within the range 0-3, and for a comb size of 2, the combOffset field may indicate an integer within the range of 0-7.

Bit 0 of the fourth row of the per-port information segment 608 (e.g., row N+7) is configured as a reserved bit. The reserved bit may be a placeholder bit for a future assignment.

Bits 1-4 of the fourth row of the per-port information segment 608 are configured as a numTotalUeId field. In some aspects, the numTotalUeId field may indicate a number of total antenna ports that are associated with a particular UE of the multiple UEs associated with the SRS section extension 600.

Bits 5-7 of the fourth row of the per-port information segment 608 are configured as a tddMuxGroup field. In some aspects, the tddMuxGroup field may indicate a TDD multiplex group that assigned to a particular SRS port (e.g., the SRS port linked to the respective per-port information). The tddMuxGroup field may indicate an integer value that is within a range of 0 and a value that is indicated by the numTddMuxGroup field in the common parameter subsection 602.

As shown by FIG. 6, the fields included in the four rows of the per-port information segment 608 may be replicated for each SRS port of the multiple SRS ports, and each iteration may customize the values in the field to be port-specific.

As described above, the symbol-specific parameter subsection 606 may include multiple iterations of the per-symbol information segment 610. As shown by FIG. 6, the first row of the per-symbol information segment 610 is equivalent to row M of the SRS section extension 600 and the second row of the per-symbol information segment 610 is equivalent to row M+1 of the SRS section extension 600.

Bit 0 of the first row of the per-symbol information 610 (e.g., row M) is configured as a seqNum field. In some aspects, the seqNum field may indicate an SRS transmission sequence, such as by indicating a sequence number that may be specified by a communications standard (e.g., v).

Bits 1-7 of the first row of the per-symbol information segment 610 are configured as a prbHopStart field. In some aspects, the prbHopStart field may indicate a per-symbol PRB hop start value, and the per-symbol PRB hop start value may be relative to a value indicated in a Section Type structure (e.g., a value that is indicated by the startPrb field associated with an SRS sampling bandwidth and not another startPrb field that is associated with a carrier bandwidth part). A first value indicated in the prbHopStart field may be used in combination with a second value indicated in the numPrb field (e.g., in a Section Type structure) to derive a starting PRB and a span of PRBs for each SRS hop.

Bits 0-3 of the second row of the per-symbol information segment 610 (e.g., row M+1) are configured as a SymtddMuxGroup field. In some aspects, the SymtddMuxGroup field may indicate a TDD multiplex group assignment of a particular symbol (e.g., the symbol is associated with the particular per-symbol information 610 instance). The SymtddMuxGroup field may indicate an integer that within a range of 0 and a value indicated by the numTddMuxGroup field in the common parameter subsection 602.

Bits 4-7 of the second row of the per-symbol information 610 are configured as a seqGroup field. In some aspects, the seqGroup field may indicate a sequence group associated with an SRS, and the seqGroup field may indicate a value of a particular sequence group that is specified by a communication standard (e.g., u).

As shown by FIG. 6, the fields included in the two rows of the per-symbol information 610 may be replicated for each symbol of an SRS port, and each iteration may customize the values in the field to be symbol-specific. That is, as described above, the symbol-specific parameter subsection 606 may include multiple iterations of the per-symbol information segment 610.

The field ordering and field sizes shown by FIG. 6 with regard to the SRS section extension 600 are examples. Other field orderings and/or field sizes may be utilized in other examples.

As indicated above, FIG. 6 is provided as an example. Other examples may differ from what is described with regard to FIG. 6.

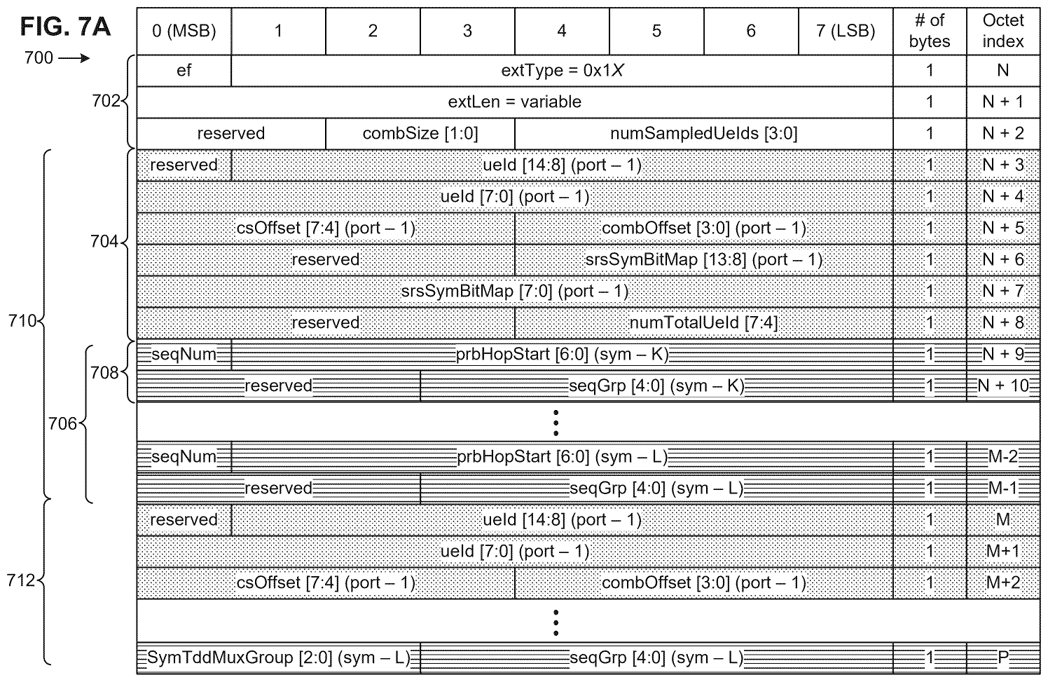

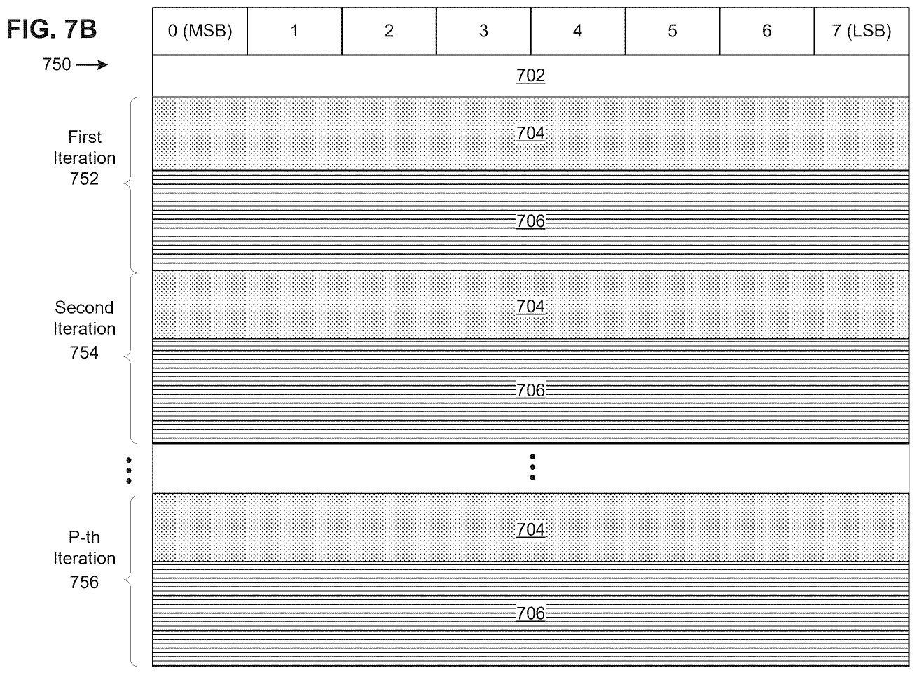

FIGS. 7A and 7B are diagrams illustrating a first example SRS section extension 700 and a second example SRS section extension 750, respectively, in accordance with the present disclosure.

The SRS section extension 700 shown by FIG. 7A is a first example section extension that may be included in a C-Plane message to provide transmission configuration information for multiple SRS ports that are associated with multiple UEs that share one or more air interface resources in a time partition and a frequency partition (e.g., to transmit a respective SRS using one or more SRS ports of the multiple SRS ports). The SRS section extension 700 may be considered additional information and/or supplemental information to Section Type information. To illustrate, information included in the SRS section extension 700 may be used in combination with information included in a Section Type 1 structure, a Section Type 3 structure, and/or a Section Type 5 structure.

The SRS section extension 700 shown by FIG. 7A is partitioned into multiple rows, and each row includes 8 bits that are ordered from the MSB (e.g., bit 0) to the LSB (e.g., bit 7). As shown by FIG. 7A, the SRS section extension 700 may be partitioned into one or more subsections that include one or more rows of the SRS section extension 700, such as a common parameters subsection 702 (shown in solid white) that indicates a first set of common parameters that are common to each SRS port of the multiple SRS ports, a per-port information segment 704 (shown with a dotted pattern) that indicates one or more per-port parameters that apply to an entirety of symbols for a respective SRS port of the multiple SRS ports, and a symbol-specific parameter subsection 706 (shown with a horizontal stripe pattern) that indicates a third set of symbol-specific parameters that are associated with the symbols of a particular SRS port. For instance, the symbol-specific parameter subsection 706 may include one or more per-symbol information segments 708, and each per-symbol information segment 708 may be specific to a respective symbol that is associated with the particular SRS port.

The SRS section extension 700 may have a variable length based at least in part on a number of SRS ports, a number of symbols (e.g., SRS symbols), and/or a number of UEs that are associated with the information included in the SRS section extension 700. To illustrate, SRS port configuration subsection 710 includes the per-port information segment 704 and the symbol-specific parameter subsection 706. In some aspects, the SRS port configuration subsection 710 may be associated with a first SRS port of the multiple SRS ports included in the SRS section extension 700, and an SRS port configuration subsection 712 (e.g., a second instance of the SRS port configuration subsection 710) may be associated with a second SRS port of the multiple SRS ports. For visual brevity, FIG. 7A only shows a portion of the SRS port configuration subsection 712. Each instance of the SRS port configuration subsection 710 may replicate some or all of the fields, and the replicated fields may be set to respective values that are associated with the respective SRS port as described below with regard to FIG. 7B.

The common parameter subsection 702 includes information that may be common to all of the SRS ports of any given UE in the multiple UEs. That is, information included in the common parameter subsection 702 may be common and/or applicable to every UE of the multiple UEs associated with the SRS section extension 700 and, consequently, every SRS port of each UE of the multiple UEs (e.g., the multiple SRS ports).

Bit 0 of the first row (e.g., row N) is configured as an ef that may be set to a first value (e.g., “0”) to indicate that no other extension for a Section Type structure is included in the C-Plane message, and a second value (e.g., “1”) to indicate that another extension for the Section Type structure is included after the SRS section extension 700. Bits 1-7 of the first row are configured as an extType field that indicates the extension type and/or format of the information included in the extension information in a similar manner as described with regard to FIG. 6.

Bits 0-7 of the second row (e.g., row N+1) are configured as an extLen field that provides a length of the extension in terms of 32-bit and/or 4-byte words. Based at least in part on the SRS section extension 700 having a variable length, the extLen field is shown by FIG. 7 has having a variable length.

Bits 0 and 1 of the third row (e.g., row N+2) are configured reserved bits. The reserved bits may be placeholder bits for a future assignment.

Bits 2 and 3 of the third row are configured as a combSize field. In a similar manner as described with regard to FIG. 6, the combSize field may indicate a transmission comb size (e.g., K_{TC}).

Bits 4-7 of the third row are configured as a numSampledUeIds field. In a similar manner as described with regard to FIG. 6, the numSampledUeIds field may indicate a total number of sounded SRS antenna ports (e.g., antenna ports used to transmit one or more SRSs) for all of the UEs specified in an SRS section extension (e.g., the SRS section extension 700).

The per-port information segment 704 may indicate one or more per-port parameters that are common, and/or apply, to an entirety of symbols for a respective SRS port of the multiple SRS ports. As shown by FIG. 7, the first row of the per-port information segment 704 is equivalent to row N+3 of the SRS section extension 700, the second row of the per-port information segment 704 is equivalent to row N+4 of the SRS section extension 700, the third row of the per-port information segment 704 is equivalent to row N+5 of the SRS section extension 700, the fourth row of the per-port information segment 704 is equivalent to row N+6 of the SRS section extension 700, the fifth row of the per-port information segment 704 is equivalent to row N+7 of the SRS section extension 700, and the sixth row of the per-port information segment 704 is equivalent to row N+8 of the SRS section extension 700.

Bit 0 of the first row of the per-port information segment 704 (e.g., row N+3) is configured as a reserved bit. In a similar manner as described above, the reserved bit may be a placeholder bit for a future assignment.

Bits 1-7 of the first row of the per-port information segment 704 are configured as a first portion of a UeId field, and bits 0-7 of the second row of the per-port information segment 704 (e.g., row N+4) are configured as a second portion of the UeId field. For example, the first portion represents bits 14-8 of the UeId field and the second portion represents bits 7-0 of the UeId field. In a similar manner as described with regard to FIG. 6, the UeId field may indicate a UE ID value, and the LSBs of the UE ID value may be configured LSBs used for SRS ports (e.g. an SRS port number used by a UE).

Bits 0-3 of the third row of the per-port information segment 704 (e.g., row N+5) are configured as a csOffset field. In a similar manner as described with regard to FIG. 6, the csOffset field may indicate a cyclic shift that is applied per SRS port within an SRS resource.

Bits 4-7 of the third row of the per-port information segment 704 are configured as a combOffset field. In a similar manner as described with regard to FIG. 6, the combOffset field may indicate a transmission comb offset (e.g., k⁻_{TC}), and the offset indicated by the combOffset field may be associated with the combSize field.

Bit 0-3 of the fourth row of the per-port information segment 704 (e.g., row N+6) are configured as reserved bits. The reserved bits may be placeholder bits for a future assignment.

Bits 4-7 of the fourth row of the per-port information segment 704 are configured as a first portion of an SRSSymBitMap field, and bits 0-7 of the fifth row of the per-port information segment 704 (e.g., row N+7) are configured as a second portion of the srsSymBitMap field. For example, the first portion represents bits 14-8 of the srsSymBitMap field and the second portion represents bits 7-0 of the srsSymBitMap field. In some aspects, the srsSymBitMap field indicates a symbol bit map that maps each respective bit to a respective symbol index of a respective symbol of the multiple symbols that are associated with an SRS port (e.g., the SRS port linked to the per-port information segment 704). The srsSymBitMap field may set each bit to a respective value to indicate whether the associated symbol is used by the SRS port (or not). For instance, a first bit value (e.g., “1”) may indicate that the respective symbol linked to the respective bit is used by the SRS port, and a second bit value (e.g., “0”) may indicate that the respective symbol is not used by the SRS port.

Bit 0-3 of the sixth row of the per-port information segment 704 (e.g., row N+8) are configured as reserved bits. The reserved bits may be placeholder bits for a future assignment.

Bits 4-7 of the sixth row of the per-port information segment 704 configured as a numTotalUeId field. In some aspects, the numTotalUeId field may indicate a number of total antenna ports that are associated with a particular UE.

As described above, the symbol-specific parameter subsection 706 may include multiple instances of the per-symbol information segment 708. As shown by FIG. 7, the first row of the first per-symbol information segment 708 is equivalent to row N+9 of the SRS section extension 700 and the second row of the per-symbol information segment 708 is equivalent to row N+10 of the SRS section extension 700.

Bit 0 of the first row of the per-symbol information segment 708 (e.g., row N+9) is configured as a seqNum field. In a similar manner as described with regard to FIG. 6, the seqNum field may indicate an SRS transmission sequence, such as by indicating a sequence number that may be specified by a communications standard (e.g., v).

Bits 1-7 of the first row of the per-symbol information segment 708 are configured as a prbHopStart field. In a similar manner as described with regard to FIG. 6, the prbHopStart field may indicate a per-symbol PRB hop start value, and the per-symbol PRB hop start value may be relative to a value indicated in a Section Type structure (e.g., a value that is indicated by the startPrb field associated with an SRS sampling bandwidth and not another startPrb field that is associated with a carrier bandwidth part). A first value indicated in the prbHopStart field may be used in combination with a second value indicated in the numPrb field (e.g., in a Section Type structure) to derive a starting PRB and a span of PRBs for each SRS hop.

Bits 0-3 of the second row of the per-symbol information segment 708 (e.g., row N+10) are configured as reserved bits. The reserved bits may be placeholder bits for a future assignment.

Bits 4-7 of the second row of the per-symbol information segment 708 are configured as a seqGroup field. In a similar manner as described with regard to FIG. 6, the seqGroup field may indicate a sequence group associated with an SRS, and the seqGroup field may indicate a value of a particular sequence group that is specified by a communication standard (e.g., u).

The SRS section extension 750 shown by FIG. 7B is a second example section extension that may be included in a C-Plane message to provide transmission configuration information for multiple SRS ports that are associated with multiple UEs. In some aspects, the SRS section extension 750 shown by FIG. 7B is a simplified version of the SRS section extension 700 shown by FIG. 700. To illustrate, the SRS section extension 750 includes the common parameters subsection 702 (shown in solid white) as described with regard to FIG. 7A. The SRS section extension 750 also includes multiple iterations of the SRS port configuration subsection 710, which are shown by FIG. 7B as first iteration 752, second iteration 754, and P-the iteration 756. P may be an integer that is equivalent to a number of SRS ports associated with the SRS section extension 750, and each iteration may be associated with a respective SRS port.

To illustrate, the first iteration 752 includes an instance of the per-port information segment 704 (shown with a dotted pattern) and an instance of the symbol-specific parameter subsection 706 (shown with a horizontal stripe pattern). As described with regard to FIG. 7A, the symbol-specific parameter subsection 706 may include multiple instances of the per-symbol information segment 708. The first iteration 752 may be associated with a first SRS port of the multiple SRS ports. Similarly, the second iteration 754 includes an instance of the per-port information segment and an instance of the symbol-specific parameter subsection 706, and the P-th iteration 756 includes an instance of the per-port information segment and an instance of the symbol-specific parameter subsection 706. Values included in the second iteration 754 may be associated with a second SRS port of the multiple SRS ports, and values included in the P-th iteration 756 may be associated with a P-th SRS port of the multiple SRS ports.

As indicated above, FIGS. 7A and 7B are provided as examples. Other examples may differ from what is described with regard to FIGS. 7A and 7B.

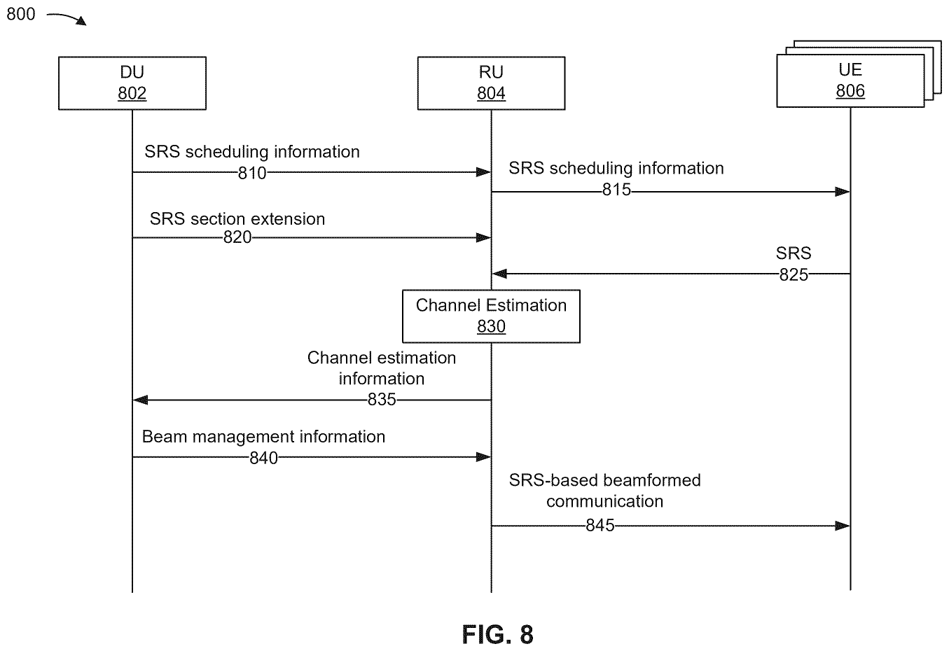

FIG. 8 is a diagram illustrating an example 800 of a wireless communication process between a DU 802 (e.g., a first network node 110), an RU 804 (e.g., a second network node 110), and one or more UEs 806 (e.g., one or more UEs 120), in accordance with the present disclosure.

As shown by reference number 810, a DU 802 may transmit, and an RU 804 may receive, SRS scheduling information. As one example, the DU 802 may transmit one or more C-plane messages that indicate SRS control information that configures one or more SRS-related parameters, such as an SRS periodicity, an SRS bandwidth, and/or SRS antenna ports. The DU 802 may transmit a single C-plane message that schedules a single SRS for a single UE of the one or more UEs 806 and/or may transmit multiple C-plane messages that schedule one or more respective SRSs for each UE of the one or more 806. In some aspects, the DU 802 may transmit the scheduling information in RRC signaling that the RU 804 transmits using physical layer signals that carry the RRC signaling and/or without the RU 804 using an RRC protocol layer for the transmission. Accordingly, and as shown by reference number 815, the RU 804 may transmit, and one or more UEs 806 may receive, the SRS scheduling information.

As shown by reference number 820, the DU 802 may transmit, and the RU 804 may receive, an SRS section extension, such as the SRS section extension 600 described with regard to FIG. 6, the SRS section extension 700 described with regard to FIG. 7A, and/or the SRS section extension 750 described with regard to FIG. 7B.

In some aspects, the SRS section extension may include a common parameter subsection that indicates a first set of common parameters that are common to each SRS port of one or more SRS ports that are associated with the SRS section extension, a port-specific parameter subsection that indicates a second set of per-port parameters that include port configuration information for an entirety of symbols (e.g., SRS symbols) used by the one or more SRS ports, and/or a symbol-specific parameter subsection that indicates a third set of symbol-specific parameters that include symbol configuration information for each symbol of the entirety of symbols used by the SRS port(s) as described with regard to FIG. 6. The common parameter subsection may include and/or indicate, as a common parameter of the first set of common parameters, a numTddMuxGroup field that indicates a number of time division duplex multiplex groups that are associated with the one or more SRS ports. Alternatively, or additionally, the common parameter subsection may include a numSampledUeId field that indicates a total number of sounded SRS antenna ports (e.g., for one or more UEs associated with the SRS section extension, such as the one or more UEs 806) and/or a combSize field that indicates a transmission comb size.

The port-specific parameter subsection of the SRS section extension may include one or more per-port information segments. Each per-port information segment may be associated with a respective SRS port of one or more ports associated with the SRS section extension and/or may include a tddMuxGrp field that indicates a TDD multiplex group that is associated with the respective SRS port. Alternatively, or additionally, each per-port information segment may include a UeId field that indicates a UE identifier of a particular UE (e.g., of the one or more UEs 806) that is associated with the respective SRS port, a combOffset field that indicates a transmission comb offset, a numTotalUeId field that indicates a total number of antenna ports that are associated with the particular UE, and/or a csOffset field that indicates a cyclic shift that is applied per-SRS-port within an SRS resource.

The symbol-specific parameter subsection of the SRS section extension may include one or more per-symbol information segments, and each per-symbol information segment may be associated with a particular symbol of a set of symbols that are associated with an SRS port (e.g., a set of SRS symbols). Each per-symbol information segment may include a SymTddMuxGrp field that indicates a TDD multiplex group that is associated with the particular symbol that is associated with the per-symbol information segment. Alternatively, or additionally, each per-symbol information segment may include a prbHopStart field that indicates a per-symbol PRB hop start value, a seqNum field that indicates a sequence number value, and/or a seqGroup field that indicates a sequence group.

In some aspects, the SRS section extension may include a common parameter subsection that indicates a first set of common parameters that are common to each SRS port of one or more SRS ports associated with the SRS section extension and one or more SRS port configuration subsections that collectively include a second set of per-port parameters that include configuration information for an entirety of symbols used by the one or more SRS ports and a third set of symbol-specific parameters that include symbol configuration information for each symbol of the entirety of symbols used by the one or more SRS ports as described with regard to FIG. 7B. Each SRS port configuration subsection included in the SRS section extension may be associated with a respective SRS port (e.g., of the one or more SRS ports associated with the SRS section extension), and each SRS port configuration subsection may include a per-port information segment that is associated with the respective SRS port, and a symbol-specific parameter subsection that is associated with a set of symbols that is associated with the respective SRS port.

The common parameter subsection of the SRS section extension may include a numSampledUeId field that indicates a total number of sounded SRS antenna ports for the one or more UEs. Alternatively, or additionally, the common parameter subsection may include a combSize field that indicates a transmission comb size.

The per-port information segment of each SRS port configuration subsection in the SRS section extension may include an srsSymbBitMap field that indicates a symbol bit map that maps each respective bit to a respective symbol index of a respective symbol of the set of the symbols. The srsSymbBitMap field may set each bit to a respective bit value that indicates whether that the respective symbol is used (or is not used) by the respective SRS port. Alternatively, or additionally, the per-port information segment of each SRS port configuration subsection in the SRS section extension may include a UeId field that indicates an SRS port number, a numTotalUeId field that indicates a total number of antenna ports that are associated with a particular UE, a combOffset field that indicates a transmission comb offset, and/or a csOffset field that indicates a cyclic shift that is applied per-SRS-port within an SRS resource. The per-port parameters in the per-port information segment may apply to each symbol in a set of symbols that are associated with a particular SRS port.

The symbol-specific parameter subsection of each SRS port configuration subsection in the SRS section extension may include one or more per-symbol information segments as described above, and each per-symbol information segment may include a prbHpStart field that indicates a per-symbol physical resource block hop start value, a seqNum field that indicates a sequence number value, and/or a seqGroup field that indicates a sequence group. Each per-symbol information segment may be associated with a respective symbol of the set of symbols that are associated with the particular SRS port.

In some aspects, the DU 802 may transmit a fronthaul C-plane message that includes multiple instances of an SRS section extension, such as multiple instances of the SRS section extension 600 described with regard to FIG. 6 and/or the SRS section extension 700 described with regard to FIG. 7A. Each SRS extension may be associated with a respective time partition (e.g., a respective slot) and/or SRS transmission(s) in the respective time slot.

Alternatively, or additionally, the DU 802 may indicate, via the fronthaul C-plane message, a type of channel estimation measurement to include in the second fronthaul C-plane message, a list of SRS ports that indicate to include, for each SRS port in the list of SRS ports, a respective channel estimation measurement metric in the one or more channel estimation measurement metrics in the second fronthaul C-plane message, and/or a frequency reporting granularity for a channel estimation measurement metric. The SRS ports included in the list of SRS ports may be SRS ports included in a single SRS section extension and/oror SRS ports included in multiple SRS section extensions (e.g., each SRS extension of the multiple SRS section extensions being associated with a respective time slot). The multiple SRS section extensions that indicate one or more SRS ports included in the list of SRS ports may be indicated by the DU 802 in a single C-plane message or multiple C-plane messages.

As shown by reference number 825, the one or more UEs 806 may transmit, and the RU 804 may receive, one or more SRSs. To illustrate the UE(s) 806 may transmit the SRS(s) based at least in part on the SRS scheduling information.

As shown by reference number 830, the RU 804 may compute a channel estimation measurement metric. In some aspects, the RU 804 may compute the channel estimation measurement metric(s) using the transmission configuration information indicated in the SRS section extension. Examples of channel estimation metrics are: the channel matrix (i.e. set of channel weights between each RU port and each SRS port included in the reporting), an eigenmode representation (where the channel matrix is represented with respect to one or multiple sets of salient principal vectors in the channel matrix space, e.g. SVD representation), uplink codeword set recommendation, beam recommendation, etc.

In some aspects, the RU 804 may compute the channel estimation measurement metric(s) based at least in part on reporting configuration information indicated by the DU 802. Examples of reporting configuration information may include a type of channel estimation measurement to include in the second fronthaul C-plane message, a list of SRS ports that indicate to include, for each SRS port in the list of SRS ports, a respective channel estimation measurement metric in the one or more channel estimation measurement metrics in the second fronthaul C-plane message, and/or a frequency reporting granularity for a channel estimation measurement metric.

Alternatively, or additionally, the multiple SRS ports As shown by reference number 835, the RU 804 may transmit, and the DU 802 may receive, channel estimation information, such as by transmitting a fronthaul C-Plane message that indicates channel estimation information computed by the RU 804 as described with regard to reference number 830. Examples of channel estimation information may include a channel response matrix (H matrix) calculated by the RU, channel singular value decomposition (SVD) information associated with the H matrix, a signal-to-interference-plus-noise ratio (SINR) metric, an eigen vector associated with the H matrix, or a codebook value that is associated with CSI.

As shown by reference number 840, the DU 802 may transmit, and the RU 804 may receive, beam management information. For instance, as described above, the beam management information may include beamforming parameter(s) and/or other transmission parameter(s) that are derived by the DU 802 using the channel state information computed by the RU 804. Accordingly, the beam management information may be based at least in part on the SRS(s) transmitted by the UE(s) 806 and/or the channel state information derived from the SRS(s) and/or the transmission configuration information indicated in the SRS section extension.

As shown by reference number 845, the RU 804 may transmit, and the one or more UEs 806 may receive, an SRS-based beamformed communication. To illustrate, the RU 804 may transmit the SRS-based beamformed communication using one or more beamforming weights that are indicated by the DU 802 as at least part of the beam management information.

A DU transmitting, and an RU receiving, a C-plane message that indicates transmission configuration information that is associated with SRS transmissions by one or more UEs that share one or more air interface resources in a time partition and a frequency partition to transmit respective SRSs may enable the RU to compute accurate CSI (e.g., CSI that satisfies an accuracy threshold) and reduce signaling overhead. Reducing a signaling overhead may result in a reduced latency for processing and exchanging messages between an RU (e.g., the RU 404) and a DU (e.g., the DU 402), increase user data throughput, decrease user data transfer latencies, and/or decrease congestion in the control plane.

As indicated above, FIG. 8 is provided as an example. Other examples may differ from what is described with regard to FIG. 8.

FIG. 9 is a diagram illustrating an example process 900 performed, for example, at an RU or an apparatus of an RU, in accordance with the present disclosure. Example process 900 is an example where the apparatus or the RU (e.g., a network node 110 and/or an RU 240) performs operations associated with techniques for an SRS section extension for channel estimation by an RU.

As shown in FIG. 9, in some aspects, process 900 may include receiving, as at least part of a first fronthaul C-plane message, an SRS section extension that indicates transmission configuration information associated with two or more SRS ports and one or more transmissions that share one or more air interface resources that span multiple symbols and one or more frequency partitions (block 910). For example, the RU (e.g., using reception component 1302 and/or communication manager 1306, depicted in FIG. 13) may receive, as at least part of a first fronthaul C-plane message, an SRS section extension that indicates transmission configuration information associated with two or more SRS ports and one or more transmissions that share one or more air interface resources that span multiple symbols and one or more frequency partitions, as described above.

As further shown in FIG. 9, in some aspects, process 900 may include transmitting, as at least part of a second fronthaul C-plane message, one or more channel estimation measurement metrics that are based at least in part on the transmission configuration information (block 920). For example, the RU (e.g., using transmission component 1304 and/or communication manager 1306, depicted in FIG. 13) may transmit, as at least part of a second fronthaul C-plane message, one or more channel estimation measurement metrics that are based at least in part on the transmission configuration information, as described above.

Process 900 may include additional aspects, such as any single aspect or any combination of aspects described below and/or in connection with one or more other processes described elsewhere herein.

In a first aspect, the SRS section extension includes a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and a symbol-specific parameter subsection that indicates a third set of symbol-specific parameters at include symbol configuration information for each symbol of the multiple symbols used by the two or more SRS ports.

In a second aspect, the common parameter subsection includes, as a common parameter of the first set of common parameters, a numTddMuxGroup field that indicates a number of time division duplex multiplex groups that are associated with the two or more SRS ports.

In a third aspect, the common parameter subsection includes, in the first set of common parameters, at least one of a numSampledUeId field that indicates a total number of sounded SRS antenna ports associated with the transmission configuration information, or a combSize field that indicates a transmission comb size.

In a fourth aspect, the port-specific parameter subsection includes, as at least part of the second set of per-port parameters, one or more per-port information segments, and each per-port information segment includes a tddMuxGrp field that indicates a time division duplex multiplex group that is associated with a respective SRS port of the two or more SRS ports that is associated with the per-port information segment.

In a fifth aspect, each per-port information segment includes at least one of a UeId field that indicates a UE identifier of a particular UE that is associated with the respective SRS port, a combOffset field that indicates a transmission comb offset, a numTotalUeId field that indicates a total number of antenna ports that are associated with the particular UE, or a csOffset field that indicates a cyclic shift that is applied per-SRS-port within an SRS resource.

In a sixth aspect, the symbol-specific parameter subsection includes, as at least part of the third set of symbol-specific parameters, one or more per-symbol information segments, and each per-symbol information segment of the one or more per-symbol information segments, includes a SymTddMuxGrp field that indicates a time division duplex multiplex group that is associated with a particular symbol of the multiple symbols that is associated with the per-symbol information segment.

In a seventh aspect, each per-symbol information segment includes at least one of a prbHopStart field that indicates a per-symbol physical resource block hop start value, a seqNum field that indicates a sequence number value, or a seqGroup field that indicates a sequence group.

In an eighth aspect, the SRS section extension, for a respective SRS port of the two or more SRS ports, comp includes rises common parameter subsection that indicates a first set of common parameters that are common to each SRS port of the two or more SRS ports, and one or more SRS port configuration subsections that collectively include a second set of per-port parameters that include configuration information for an entirety of symbols used by the two or more SRS ports and a third set of symbol-specific parameters that include symbol configuration information for each symbol of the entirety of the multiple symbols used by the two or more SRS ports, each SRS port configuration subsection of the one or more SRS port configuration subsection includes a per-port information segment that is associated with a respective SRS port of the two or more SRS ports, and a symbol-specific parameter subsection that is associated with a set of symbols, from the entirety of the symbols, that is associated with the respective SRS port.

In a ninth aspect, the common parameter subsection includes, in the first set of common parameters, a numSampledUeId field that indicates a total number of sounded SRS antenna ports associated with the transmission configuration information.

In a tenth aspect, the common parameter subsection includes, in the first set of common parameters, a combSize field that indicates a transmission comb size.

In an eleventh aspect, the per-port information segment includes an srsSymbBitMap field that indicates a symbol bit map that maps each respective bit to a respective symbol index of a respective symbol of the set of the symbols, the respective bit being set to a first bit value indicates that the respective symbol is used by the respective SRS port, and the respective bit being set to a second bit value indicates that the respective symbol is not used by the respective SRS port.

In a twelfth aspect, the per-port information segment includes at least one of a UeId field that indicates an SRS port number, a numTotalUeId field that indicates a total number of antenna ports that are associated with a particular UE associated with the two or more SRS ports, a combOffset field that indicates a transmission comb offset, or a csOffset field that indicates a cyclic shift that is applied per-SRS-port within an SRS resource.

In a thirteenth aspect, the symbol-specific parameter subsection includes one or more per-symbol information segments, and each per-symbol information segment of the one or more per-symbol information segments includes at least one of a prbHopStart field that indicates a per-symbol physical resource block hop start value, a seqNum field that indicates a sequence number value, or a seqGroup field that indicates a sequence group.

In a fourteenth aspect, the second fronthaul C-Plane message indicates at least one of an H matrix calculated by the RU, channel singular value decomposition (SVD) information associated with the H matrix, a signal-to-interference-plus-noise ratio (SINR) metric, an eigen vector associated with the H matrix, or a codebook value that is associated with channel state information.

In a fifteenth aspect, the first fronthaul C-plane message includes multiple instances of the SRS section extension, each SRS extension being associated with a respective time partition.

In a sixteenth aspect, process 900 includes computing the one or more channel estimation measurement metrics based at least in part on the transmission configuration information.

In a seventeenth aspect, the first fronthaul C-plane message indicates at least one of a type of channel estimation measurement to include in the second fronthaul C-plane message, a list of SRS ports, from the two or more SRS ports, that indicate to include, for each SRS port in the list of SRS ports, a respective channel estimation measurement metric in the one or more channel estimation measurement metrics in the second fronthaul C-plane message, or a frequency reporting granularity.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a DU or an apparatus of a DU, in accordance with the present disclosure. Example process 1000 is an example where the apparatus or the DU (e.g., a network node 110 and/or a DU 230) performs operations associated with techniques for a SRS section extension for channel estimation by an RU.

As shown in FIG. 10, in some aspects, process 1000 may include transmitting, as at least part of a first fronthaul C-plane message, an SRS section extension that indicates transmission configuration information associated two or more SRS ports and one or more transmissions that share one or more air interface resources that span multiple symbols and one or more frequency partitions (block 1010). For example, the DU (e.g., using transmission component 1304 and/or communication manager 1306, depicted in FIG. 13) may transmit, as at least part of a first fronthaul C-plane message, an SRS section extension that indicates transmission configuration information associated two or more SRS ports and one or more transmissions that share one or more air interface resources that span multiple symbols and one or more frequency partitions, as described above.

As further shown in FIG. 10, in some aspects, process 1000 may include receiving, as at least part of a second fronthaul C-plane message, one or more channel estimation measurement metrics that are based at least in part on the transmission configuration information (block 1020). For example, the DU (e.g., using reception component 1302 and/or communication manager 1306, depicted in FIG. 13) may receive, as at least part of a second fronthaul C-plane message, one or more channel estimation measurement metrics that are based at least in part on the transmission configuration information, as described above.

Process 1000 may include additional aspects, such as any single aspect or any combination of aspects described below and/or in connection with one or more other processes described elsewhere herein.

In a first aspect, the SRS section extension includes a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and a symbol-specific parameter subsection that indicates a third set of symbol-specific parameters at include symbol configuration information for each symbol of the multiple symbols used by the two or more SRS ports.

In a second aspect, the common parameter subsection includes, as a common parameter of the first set of common parameters, a numTddMuxGroup field that indicates a number of time division duplex multiplex groups that are associated with the two or more SRS ports.

In a third aspect, the common parameter subsection includes, in the first set of common parameters, at least one of a numSampledUeId field that indicates a total number of sounded SRS antenna ports associated with the transmission configuration information, or a combSize field that indicates a transmission comb size.

In a fourth aspect, the port-specific parameter subsection includes, as at least part of the second set of per-port parameters, one or more per-port information segments, and each per-port information segment includes a tddMuxGrp field that indicates a time division duplex multiplex group that is associated with a respective SRS port of the two or more SRS ports that is associated with the per-port information segment.

In a fifth aspect, each per-port information segment includes at least one of a UeId field that indicates a UE identifier of a particular UE that is associated with the respective SRS port, a combOffset field that indicates a transmission comb offset, a numTotalUeId field that indicates a total number of antenna ports that are associated with the particular UE, or a csOffset field that indicates a cyclic shift that is applied per-SRS-port within an SRS resource.

In a sixth aspect, the symbol-specific parameter subsection includes, as at least part of the third set of symbol-specific parameters, one or more per-symbol information segments, and each per-symbol information segment of the one or more per-symbol information segments, includes a SymTddMuxGrp field that indicates a time division duplex multiplex group that is associated with a particular symbol of the multiple symbols that is associated with the per-symbol information segment.

In a seventh aspect, each per-symbol information segment includes at least one of a prbHopStart field that indicates a per-symbol physical resource block hop start value, a seqNum field that indicates a sequence number value, or a seqGroup field that indicates a sequence group.

In an eighth aspect, the SRS section extension, for a respective SRS port of the two or more SRS ports, includes a common parameter subsection that indicates a first set of common parameters that are common to each SRS port of the two or more SRS ports, and one or more SRS port configuration subsections that collectively include a second set of per-port parameters that include configuration information for an entirety of symbols used by the two or more SRS ports and a third set of symbol-specific parameters that include symbol configuration information for each symbol of the entirety of symbols used by the two or more SRS ports, each SRS port configuration subsection of the one or more SRS port configuration subsection includes a per-port information segment that is associated with a respective SRS port of the two or more SRS ports, and a symbol-specific parameter subsection that is associated with a set of symbols, from the entirety of the symbols, that is associated with the respective SRS port.

In a ninth aspect, the common parameter subsection includes, in the first set of common parameters, a numSampledUeId field that indicates a total number of sounded SRS antenna ports associated with the transmission configuration information.

In a tenth aspect, the common parameter subsection includes, in the first set of common parameters, a combSize field that indicates a transmission comb size.

In an eleventh aspect, the per-port information segment includes an srsSymbBitMap field that indicates a symbol bit map that maps each respective bit to a respective symbol index of a respective symbol of the set of the symbols, the respective bit being set to a first bit value indicates that the respective symbol is used by the respective SRS port, and the respective bit being set to a second bit value indicates that the respective symbol is not used by the respective SRS port.

In a twelfth aspect, the per-port information segment includes at least one of a UeId field that indicates an SRS port number, a numTotalUeId field that indicates a total number of antenna ports that are associated with a particular UE associated with the two or more SRS ports, a combOffset field that indicates a transmission comb offset, or a csOffset field that indicates a cyclic shift that is applied per-SRS-port within an SRS resource.

In a thirteenth aspect, the symbol-specific parameter subsection includes one or more per-symbol information segments, and each per-symbol information segment of the one or more per-symbol information segments includes at least one of a prbHopStart field that indicates a per-symbol physical resource block hop start value, a seqNum field that indicates a sequence number value, or a seqGroup field that indicates a sequence group.

In a fourteenth aspect, the second fronthaul C-Plane message indicates at least one of an H matrix calculated by an RU, a channel SVD information associated with the H matrix, an SINR metric, an eigen vector associated with the H matrix, or a codebook value that is associated with channel state information.

In a fifteenth aspect, the first fronthaul C-plane message includes multiple instances of the SRS section extension, each SRS extension being associated with a respective time partition.

In a sixteenth aspect, process 1000 includes computing the one or more channel estimation measurement metrics based at least in part on the transmission configuration information.

In a seventeenth aspect, the first fronthaul C-plane message indicates at least one of a type of channel estimation measurement to include in the second fronthaul C-plane message, a list of SRS ports, from the two or more SRS ports, that indicate to include, for each SRS port in the list of SRS ports, a respective channel estimation measurement metric in the one or more channel estimation measurement metrics in the second fronthaul C-plane message, or a frequency reporting granularity.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at an RU or an apparatus of an RU, in accordance with the present disclosure. Example process 1100 is an example where the apparatus or the RU (e.g., a network node 110 and/or an RU 240) performs operations associated with techniques for a SRS section extension for channel estimation by an RU.

As shown in FIG. 11, in some aspects, process 1100 may include receiving, as at least part of a first fronthaul C-plane message, an SRS section extension that indicates transmission configuration information associated with two or more SRS port and one or more transmissions that share one or more air interface resources that span multiple symbols and one or more frequency partitions (block 1110). For example, the RU (e.g., using reception component 1302 and/or communication manager 1306, depicted in FIG. 13) may receive, as at least part of a first fronthaul C-plane message, an SRS section extension that indicates transmission configuration information associated with two or more SRS port and one or more transmissions that share one or more air interface resources that span multiple symbols and one or more frequency partitions, as described above.

As further shown in FIG. 11, in some aspects, process 1100 may include transmitting, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of: multiple SRS ports, of the two or more SRS ports, in a same SRS section extensions, or multiple SRS ports that are indicated by multiple SRS section extensions (block 1120). For example, the RU (e.g., using transmission component 1304 and/or communication manager 1306, depicted in FIG. 13) may transmit, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of: multiple SRS ports, of the two or more SRS ports, in a same SRS section extensions, or multiple SRS ports that are indicated by multiple SRS section extensions, as described above.

Process 1100 may include additional aspects, such as any single aspect or any combination of aspects described below and/or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at an RU or an apparatus of an RU, in accordance with the present disclosure. Example process 1200 is an example where the apparatus or the RU (e.g., a network node 110 and/or an RU 240) performs operations associated with techniques for an SRS section extension for channel estimation by an RU.

As shown in FIG. 12, in some aspects, process 1200 may include receiving, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols (block 1210). For example, the RU (e.g., using reception component 1302 and/or communication manager 1306, depicted in FIG. 13) may receive, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols, as described above.

As further shown in FIG. 12, in some aspects, process 1200 may include transmitting, as at least part of a second fronthaul C-plane message, one or more channel estimation measurement metrics that are based at least in part on the transmission configuration information (block 1220). For example, the RU (e.g., using transmission component 1304 and/or communication manager 1306, depicted in FIG. 13) may transmit, as at least part of a second fronthaul C-plane message, one or more channel estimation measurement metrics that are based at least in part on the transmission configuration information, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. In some aspects, the apparatus 1300 may be an RU, or an RU may include the apparatus 1300. In other aspects, the apparatus 1300 may be a DU, or a DU may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the RU and/or the DU.

In some aspects, the apparatus 1300 may be configured to perform one or more operations described herein in connection with FIGS. 4-8. Additionally, or alternatively, the apparatus 1300 may be configured to perform one or more processes described herein, such as process 900 of FIG. 9, process 1000 of FIG. 10, process 1100 of FIG. 11, process 1200 of FIG. 12, or a combination thereof. In some aspects, the apparatus 1300 and/or one or more components shown in FIG. 13 may include one or more components of the RU or the DU (e.g., a network node 110) described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the RU or the DU described above in connection with FIG. 1 (e.g., a network node 110), such as a radio, one or more RF chains, one or more transceivers, or one or more modems, each of which may in turn be coupled with one or more antennas of the RU.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the RU described above in connection with FIG. 1, such as a radio, one or more RF chains, one or more transceivers, or one or more modems, each of which may in turn be coupled with one or more antennas of the RU described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

Based at least in part on the apparatus 1300 being an RU, or an RU including the apparatus 1300, the reception component 1302 may receive, as at least part of a first fronthaul C-plane message, an SRS section extension that indicates transmission configuration information associated with two or more SRS ports and one or more transmissions that share one or more air interface resources that span multiple symbols and one or more frequency partitions. The transmission component 1304 may transmit, as at least part of a second fronthaul C-plane message, one or more channel estimation measurement metrics that are based at least in part on the transmission configuration information. In some aspects, he communication manager 1306 may compute the one or more channel estimation measurement metrics based at least in part on the transmission configuration information.

Alternatively, or additionally, the reception component 1302 may receive, as at least part of a first fronthaul C-plane message, an SRS section extension that indicates transmission configuration information associated with two or more SRS port and one or more transmissions that share one or more air interface resources that span multiple symbols and one or more frequency partitions. The transmission component 1304 may transmit, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of multiple SRS ports, of the two or more SRS ports, in a same SRS section extensions, or multiple SRS ports that are indicated by multiple SRS section extensions.

Alternatively, or additionally, the reception component 1302 may receive, as at least part of a first fronthaul C-plane message, an SRS section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols. The transmission component 1304 may transmit, as at least part of a second fronthaul C-plane message, one or more channel estimation measurement metrics that are based at least in part on the transmission configuration information.

Based at least in part on the apparatus 1300 being a DU, or a DU including the apparatus 1300, the transmission component 1304 may transmit, as at least part of a first fronthaul C-plane message, an SRS section extension that indicates transmission configuration information associated two or more SRS ports and one or more transmissions that share one or more air interface resources that span multiple symbols and one or more frequency partitions. The reception component 1302 may receive, as at least part of a second fronthaul C-plane message, one or more channel estimation measurement metrics that are based at least in part on the transmission configuration information. The communication manager 1306 may compute the one or more channel estimation measurement metrics based at least in part on the transmission configuration information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a radio unit (RU), comprising: receiving, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions; and transmitting, as at least part of a second fronthaul C-plane message, one or more channel estimation measurement metrics that are based at least in part on the transmission configuration information.

Aspect 2: The method of Aspect 1, wherein the SRS section extension comprises: a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and a symbol-specific parameter subsection that indicates a third set of symbol-specific parameters at include symbol configuration information for each symbol of the multiple symbols used by the two or more SRS ports.

Aspect 3: The method of Aspect 2, wherein the common parameter subsection includes, as a common parameter of the first set of common parameters, a numTddMuxGroup field that indicates a number of time division duplex multiplex groups that are associated with the two or more SRS ports.

Aspect 4: The method of Aspect 2 or Aspect 3, wherein the common parameter subsection includes, in the first set of common parameters, at least one of: a numSampledUeId field that indicates a total number of sounded SRS antenna ports associated with the transmission configuration information, or a combSize field that indicates a transmission comb size.

Aspect 5: The method of any one of Aspects 2-4, wherein the port-specific parameter subsection includes, as at least part of the second set of per-port parameters, one or more per-port information segments, and wherein each per-port information segment includes a tddMuxGrp field that indicates a time division duplex multiplex group that is associated with a respective SRS port of the two or more SRS ports that is associated with the per-port information segment.

Aspect 6: The method of any one of Aspects 2-5, wherein each per-port information segment includes at least one of: a UeId field that indicates a UE identifier of a particular user equipment (UE) that is associated with the respective SRS port, a combOffset field that indicates a transmission comb offset, a numTotalUeId field that indicates a total number of antenna ports that are associated with the particular UE, or a csOffset field that indicates a cyclic shift that is applied per-SRS-port within an SRS resource.

Aspect 7: The method of any one of Aspects 2-6, wherein the symbol-specific parameter subsection includes, as at least part of the third set of symbol-specific parameters, one or more per-symbol information segments, and wherein each per-symbol information segment of the one or more per-symbol information segments, includes a SymTddMuxGrp field that indicates a time division duplex multiplex group that is associated with a particular symbol of the multiple symbols that is associated with the per-symbol information segment.

Aspect 8: The method of any one of Aspects 2-7, wherein each per-symbol information segment includes at least one of: a prbHopStart field that indicates a per-symbol physical resource block hop start value, a seqNum field that indicates a sequence number value, or a seqGroup field that indicates a sequence group.

Aspect 9: The method of any of Aspects 1, wherein the SRS section extension, for a respective SRS port of the two or more SRS ports, comprises: common parameter subsection that indicates a first set of common parameters that are common to each SRS port of the two or more SRS ports, and one or more SRS port configuration subsections that collectively include a second set of per-port parameters that include configuration information for an entirety of symbols used by the two or more SRS ports and a third set of symbol-specific parameters that include symbol configuration information for each symbol of the entirety of the multiple symbols used by the two or more SRS ports, wherein each SRS port configuration subsection of the one or more SRS port configuration subsection comprises: a per-port information segment that is associated with a respective SRS port of the two or more SRS ports, and a symbol-specific parameter subsection that is associated with a set of symbols, from the entirety of the symbols, that is associated with the respective SRS port.

Aspect 10: The method of Aspect 9, wherein the common parameter subsection includes, in the first set of common parameters, a numSampledUeId field that indicates a total number of sounded SRS antenna ports associated with the transmission configuration information.

Aspect 11: The method of Aspect 9 or Aspect 10, wherein the common parameter subsection includes, in the first set of common parameters, a combSize field that indicates a transmission comb size.

Aspect 12: The method of any one of Aspects 9-11, wherein the per-port information segment includes an srsSymbBitMap field that indicates a symbol bit map that maps each respective bit to a respective symbol index of a respective symbol of the set of the symbols, wherein the respective bit being set to a first bit value indicates that the respective symbol is used by the respective SRS port, and wherein the respective bit being set to a second bit value indicates that the respective symbol is not used by the respective SRS port.

Aspect 13: The method of any one of Aspects 9-12, wherein the per-port information segment includes at least one of: a UeId field that indicates an SRS port number, a numTotalUeId field that indicates a total number of antenna ports that are associated with a particular user equipment (UE) associated with the two or more SRS ports, a combOffset field that indicates a transmission comb offset, or a csOffset field that indicates a cyclic shift that is applied per-SRS-port within an SRS resource.

Aspect 14: The method of any one of Aspects 9-13, wherein the symbol-specific parameter subsection includes one or more per-symbol information segments, and wherein each per-symbol information segment of the one or more per-symbol information segments includes at least one of: a prbHopStart field that indicates a per-symbol physical resource block hop start value, a seqNum field that indicates a sequence number value, or a seqGroup field that indicates a sequence group.

Aspect 15: The method of any of Aspects 1-14, wherein the second fronthaul C-Plane message indicates at least one of: a channel response matrix (H matrix) calculated by the RU, a channel singular value decomposition information associated with the H matrix, a signal-to-interference-plus-noise ratio metric, an eigen vector associated with the H matrix, or a codebook value that is associated with channel state information.

Aspect 16: The method of any of Aspects 1-15, wherein the first fronthaul C-plane message includes multiple instances of the SRS section extension, each SRS extension being associated with a respective time partition.

Aspect 17: The method of any of Aspects 1-16, further comprising: computing the one or more channel estimation measurement metrics based at least in part on the transmission configuration information.

Aspect 18: The method of any of Aspects 1-17, wherein the first fronthaul C-plane message indicates at least one of: a type of channel estimation measurement to include in the second fronthaul C-plane message, a list of SRS ports, from the two or more SRS ports, that indicate to include, for each SRS port in the list of SRS ports, a respective channel estimation measurement metric in the one or more channel estimation measurement metrics in the second fronthaul C-plane message, or a frequency reporting granularity.

Aspect 19: A method of wireless communication performed by a distributed unit (DU), comprising: transmitting, as at least part of a first fronthaul control plane (C-plane) message, a sounding reference signal (SRS) section extension that indicates transmission configuration information associated two or more SRS ports and one or more transmissions that share one or more air interface resources that span multiple symbols and one or more frequency partitions; and receiving, as at least part of a second fronthaul C-plane message, one or more channel estimation measurement metrics that are based at least in part on the transmission configuration information.

Aspect 20: The method of Aspect 19, wherein the SRS section extension comprises: a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and a symbol-specific parameter subsection that indicates a third set of symbol-specific parameters at include symbol configuration information for each symbol of the multiple symbols used by the two or more SRS ports.

Aspect 21: The method of Aspect 20, wherein the common parameter subsection includes, as a common parameter of the first set of common parameters, a numTddMuxGroup field that indicates a number of time division duplex multiplex groups that are associated with the two or more SRS ports.

Aspect 22: The method of Aspect 20 or Aspect 21, wherein the common parameter subsection includes, in the first set of common parameters, at least one of: a numSampledUeId field that indicates a total number of sounded SRS antenna ports associated with the transmission configuration information, or a combSize field that indicates a transmission comb size.

Aspect 23: The method of any one of Aspects 20-22, wherein the port-specific parameter subsection includes, as at least part of the second set of per-port parameters, one or more per-port information segments, and wherein each per-port information segment includes a tddMuxGrp field that indicates a time division duplex multiplex group that is associated with a respective SRS port of the two or more SRS ports that is associated with the per-port information segment.

Aspect 24: The method of any one of Aspects 20-23, wherein each per-port information segment includes at least one of: a UeId field that indicates a UE identifier of a particular user equipment (UE) that is associated with the respective SRS port, a combOffset field that indicates a transmission comb offset, a numTotalUeId field that indicates a total number of antenna ports that are associated with the particular UE, or a csOffset field that indicates a cyclic shift that is applied per-SRS-port within an SRS resource.

Aspect 25: The method any one of Aspects 20-24, wherein the symbol-specific parameter subsection includes, as at least part of the third set of symbol-specific parameters, one or more per-symbol information segments, and wherein each per-symbol information segment of the one or more per-symbol information segments, includes a SymTddMuxGrp field that indicates a time division duplex multiplex group that is associated with a particular symbol of the multiple symbols that is associated with the per-symbol information segment.

Aspect 26: The method of any one of Aspects 20-25, wherein each per-symbol information segment includes at least one of: a prbHopStart field that indicates a per-symbol physical resource block hop start value, a seqNum field that indicates a sequence number value, or a seqGroup field that indicates a sequence group.

Aspect 27: The method of any of Aspects 19, wherein the SRS section extension, for a respective SRS port of the two or more SRS ports, comprises: a common parameter subsection that indicates a first set of common parameters that are common to each SRS port of the two or more SRS ports, and one or more SRS port configuration subsections that collectively include a second set of per-port parameters that include configuration information for an entirety of symbols used by the two or more SRS ports and a third set of symbol-specific parameters that include symbol configuration information for each symbol of the entirety of symbols used by the two or more SRS ports, wherein each SRS port configuration subsection of the one or more SRS port configuration subsection comprises: a per-port information segment that is associated with a respective SRS port of the two or more SRS ports, and a symbol-specific parameter subsection that is associated with a set of symbols, from the entirety of the symbols, that is associated with the respective SRS port.

Aspect 28: The method of Aspect 27, wherein the common parameter subsection includes, in the first set of common parameters, a numSampledUeId field that indicates a total number of sounded SRS antenna ports associated with the transmission configuration information.

Aspect 29: The method of Aspect 27 or Aspect 28, wherein the common parameter subsection includes, in the first set of common parameters, a combSize field that indicates a transmission comb size.

Aspect 30: The method of any one of Aspects 27-29, wherein the per-port information segment includes an srsSymbBitMap field that indicates a symbol bit map that maps each respective bit to a respective symbol index of a respective symbol of the set of the symbols, wherein the respective bit being set to a first bit value indicates that the respective symbol is used by the respective SRS port, and wherein the respective bit being set to a second bit value indicates that the respective symbol is not used by the respective SRS port.

Aspect 31: The method of any one of Aspects 27-30, wherein the per-port information segment includes at least one of: a UeId field that indicates an SRS port number, a numTotalUeId field that indicates a total number of antenna ports that are associated with a particular user equipment (UE) associated with the two or more SRS ports, a combOffset field that indicates a transmission comb offset, or a csOffset field that indicates a cyclic shift that is applied per-SRS-port within an SRS resource.

Aspect 32: The method of any one of Aspects 27-31, wherein the symbol-specific parameter subsection includes one or more per-symbol information segments, and wherein each per-symbol information segment of the one or more per-symbol information segments includes at least one of: a prbHopStart field that indicates a per-symbol physical resource block hop start value, a seqNum field that indicates a sequence number value, or a seqGroup field that indicates a sequence group.

Aspect 33: The method of any of Aspects 19, wherein the second fronthaul C-Plane message indicates at least one of: a channel response matrix (H matrix) calculated by a radio unit, a channel singular value decomposition information associated with the H matrix, a signal-to-interference-plus-noise ratio metric, an eigen vector associated with the H matrix, or a codebook value that is associated with channel state information.

Aspect 34: The method of any of Aspects 19-33, wherein the first fronthaul C-plane message includes multiple instances of the SRS section extension, each SRS extension being associated with a respective time partition.

Aspect 35: The method of any of Aspects 19-34, further comprising: computing the one or more channel estimation measurement metrics based at least in part on the transmission configuration information.

Aspect 36: The method of any of Aspects 19-35, wherein the first fronthaul C-plane message indicates at least one of: a type of channel estimation measurement to include in the second fronthaul C-plane message, a list of SRS ports, from the two or more SRS ports, that indicate to include, for each SRS port in the list of SRS ports, a respective channel estimation measurement metric in the one or more channel estimation measurement metrics in the second fronthaul C-plane message, or a frequency reporting granularity.

Aspect 37: A method of wireless communication performed by a radio unit (RU), comprising: receiving, as at least part of a first fronthaul control plane (C-plane) message, a sounding reference signal (SRS) section extension that indicates transmission configuration information associated with two or more SRS port and one or more transmissions that share one or more air interface resources that span multiple symbols and one or more frequency partitions; and transmitting, as at least part of a second fronthaul C-plane message, one or more channel estimation measurement metrics that are based at least in part on the transmission configuration information, at least one channel estimation measurement metric of the one or more channel estimation measurement metrics being based at least in part on at least one of: multiple SRS ports, of the two or more SRS ports, in a same SRS section extensions, or multiple SRS ports that are indicated by multiple SRS section extensions.

Aspect 38: A method of wireless communication performed by a radio unit (RU), comprising: receiving, as at least part of a first fronthaul control plane (C-plane) message, a sounding reference signal (SRS) section extension that indicates transmission configuration information associated with at least one SRS port and one or more transmissions that share one or more air interface resources that span multiple symbols and one or more frequency partitions, at least a first SRS port of the at least one SRS port being associated with a subset of symbols from the multiple symbols; and transmitting, as at least part of a second fronthaul C-plane message, one or more channel estimation measurement metrics that are based at least in part on the transmission configuration information.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 40: An apparatus for wireless communication at a device, the apparatus comprising one or more memories and one or more processors coupled to the one or more memories, the one or more processors configured to cause the device to perform the method of one or more of Aspects 1-18.

Aspect 41: An apparatus for wireless communication, the apparatus comprising at least one means for performing the method of one or more of Aspects 1-18.

Aspect 42: A non-transitory computer-readable medium storing code for wireless communication, the code comprising instructions executable by one or more processors to perform the method of one or more of Aspects 1-18.

Aspect 43: A non-transitory computer-readable medium storing a set of instructions for wireless communication, the set of instructions comprising one or more instructions that, when executed by one or more processors of a device, cause the device to perform the method of one or more of Aspects 1-18.

Aspect 44: A device for wireless communication, the device comprising a processing system that includes one or more processors and one or more memories coupled with the one or more processors, the processing system configured to cause the device to perform the method of one or more of Aspects 1-18.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-18.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 19-36.

Aspect 47: An apparatus for wireless communication at a device, the apparatus comprising one or more memories and one or more processors coupled to the one or more memories, the one or more processors configured to cause the device to perform the method of one or more of Aspects 19-36.

Aspect 48: An apparatus for wireless communication, the apparatus comprising at least one means for performing the method of one or more of Aspects 1-38.

Aspect 49: A non-transitory computer-readable medium storing code for wireless communication, the code comprising instructions executable by one or more processors to perform the method of one or more of Aspects 19-36.

Aspect 50: A non-transitory computer-readable medium storing a set of instructions for wireless communication, the set of instructions comprising one or more instructions that, when executed by one or more processors of a device, cause the device to perform the method of one or more of Aspects 19-36.

Aspect 51: A device for wireless communication, the device comprising a processing system that includes one or more processors and one or more memories coupled with the one or more processors, the processing system configured to cause the device to perform the method of one or more of Aspects 19-36.

Aspect 52: An apparatus for wireless communication at a device, the apparatus comprising one or more memories and one or more processors coupled to the one or more memories, the one or more processors individually or collectively configured to cause the device to perform the method of one or more of Aspects 19-36.

Aspect 53: An apparatus for wireless communication at a device, the apparatus comprising one or more processors; one or more memories coupled with the one or more processors; and instructions stored in the one or more memories and executable by the one or more processors to cause the apparatus to perform the method of Aspect 37.

Aspect 54: An apparatus for wireless communication at a device, the apparatus comprising one or more memories and one or more processors coupled to the one or more memories, the one or more processors configured to cause the device to perform the method of Aspect 37.

Aspect 55: An apparatus for wireless communication, the apparatus comprising at least one means for performing the method of Aspect 37.

Aspect 56: A non-transitory computer-readable medium storing code for wireless communication, the code comprising instructions executable by one or more processors to perform the method of Aspect 37.

Aspect 57: A non-transitory computer-readable medium storing a set of instructions for wireless communication, the set of instructions comprising one or more instructions that, when executed by one or more processors of a device, cause the device to perform the method of Aspect 37.

Aspect 58: A device for wireless communication, the device comprising a processing system that includes one or more processors and one or more memories coupled with the one or more processors, the processing system configured to cause the device to perform the method of Aspect 37.

Aspect 59: An apparatus for wireless communication at a device, the apparatus comprising one or more memories and one or more processors coupled to the one or more memories, the one or more processors individually or collectively configured to cause the device to perform the method of Aspect 37.

Aspect 60: An apparatus for wireless communication at a device, the apparatus comprising one or more processors; one or more memories coupled with the one or more processors; and instructions stored in the one or more memories and executable by the one or more processors to cause the apparatus to perform the method of Aspect 38.

Aspect 61: An apparatus for wireless communication at a device, the apparatus comprising one or more memories and one or more processors coupled to the one or more memories, the one or more processors configured to cause the device to perform the method of Aspect 38.

Aspect 62: An apparatus for wireless communication, the apparatus comprising at least one means for performing the method of Aspect 38.

Aspect 63: A non-transitory computer-readable medium storing code for wireless communication, the code comprising instructions executable by one or more processors to perform the method of Aspect 38.

Aspect 64: A non-transitory computer-readable medium storing a set of instructions for wireless communication, the set of instructions comprising one or more instructions that, when executed by one or more processors of a device, cause the device to perform the method of Aspect 38.

Aspect 65: A device for wireless communication, the device comprising a processing system that includes one or more processors and one or more memories coupled with the one or more processors, the processing system configured to cause the device to perform the method of Aspect 38.

Aspect 66: An apparatus for wireless communication at a device, the apparatus comprising one or more memories and one or more processors coupled to the one or more memories, the one or more processors individually or collectively configured to cause the device to perform the method of Aspect 38.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a radio unit (RU), comprising:
one or more memories; and
one or more processors, coupled to the one or more memories, configured to cause the RU to:
receive, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions; and
transmit, as at least part of a second fronthaul C-plane message, one or more channel estimation measurement metrics that are based at least in part on the transmission configuration information.

2. The apparatus of claim 1, wherein the SRS section extension comprises:
a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and
a symbol-specific parameter subsection that indicates a third set of symbol-specific parameters at include symbol configuration information for each symbol of the multiple symbols used by the two or more SRS ports.

3. The apparatus of claim 2, wherein the common parameter subsection includes, as a common parameter of the first set of common parameters, a numTddMuxGroup field that indicates a number of time division duplex multiplex groups that are associated with the two or more SRS ports.

4. The apparatus of claim 2, wherein the port-specific parameter subsection includes, as at least part of the second set of per-port parameters, one or more per-port information segments, and
wherein each per-port information segment includes a tddMuxGrp field that indicates a time division duplex multiplex group that is associated with a respective SRS port of the two or more SRS ports that is associated with the per-port information segment.

5. The apparatus of claim 2, wherein the symbol-specific parameter subsection includes, as at least part of the third set of symbol-specific parameters, one or more per-symbol information segments, and
wherein each per-symbol information segment of the one or more per-symbol information segments, includes a SymTddMuxGrp field that indicates a time division duplex multiplex group that is associated with a particular symbol of the multiple symbols that is associated with the per-symbol information segment.

6. The apparatus of claim 5, wherein each per-symbol information segment includes at least one of:
a prbHopStart field that indicates a per-symbol physical resource block hop start value,
a seqNum field that indicates a sequence number value, or
a seqGroup field that indicates a sequence group.

7. The apparatus of claim 1, wherein the SRS section extension, for a respective SRS port of the two or more SRS ports, comprises:
common parameter subsection that indicates a first set of common parameters that are common to each SRS port of the two or more SRS ports, and
one or more SRS port configuration subsections that collectively include a second set of per-port parameters that include configuration information for an entirety of symbols used by the two or more SRS ports and a third set of symbol-specific parameters that include symbol configuration information for each symbol of the entirety of the multiple symbols used by the two or more SRS ports,
wherein each SRS port configuration subsection of the one or more SRS port configuration subsection comprises:
a per-port information segment that is associated with a respective SRS port of the two or more SRS ports, and
a symbol-specific parameter subsection that is associated with a set of symbols, from the entirety of the symbols, that is associated with the respective SRS port.

8. The apparatus of claim 7, wherein the common parameter subsection includes, in the first set of common parameters, a numSampledUeId field that indicates a total number of sounded SRS antenna ports associated with the transmission configuration information.

9. The apparatus of claim 7, wherein the per-port information segment includes an srsSymbBitMap field that indicates a symbol bit map that maps each respective bit to a respective symbol index of a respective symbol of the set of the symbols,
wherein the respective bit being set to a first bit value indicates that the respective symbol is used by the respective SRS port, and
wherein the respective bit being set to a second bit value indicates that the respective symbol is not used by the respective SRS port.

10. The apparatus of claim 7, wherein the symbol-specific parameter subsection includes one or more per-symbol information segments, and
wherein each per-symbol information segment of the one or more per-symbol information segments includes at least one of:
a prbHopStart field that indicates a per-symbol physical resource block hop start value,
a seqNum field that indicates a sequence number value, or
a seqGroup field that indicates a sequence group.

11. The apparatus of claim 1 wherein the second fronthaul C-Plane message indicates at least one of:
a channel response matrix (H matrix) calculated by the RU,
a channel singular value decomposition information associated with the H matrix,
a signal-to-interference-plus-noise ratio metric,
an eigen vector associated with the H matrix, or
a codebook value that is associated with channel state information.

12. The apparatus of claim 1, wherein the first fronthaul C-plane message includes multiple instances of the SRS section extension, each SRS extension being associated with a respective time partition.

13. The apparatus of claim 1, wherein the one or more processors are further configured to cause the RU to:
compute the one or more channel estimation measurement metrics based at least in part on the transmission configuration information.

14. The apparatus of claim 1, wherein the first fronthaul C-plane message indicates at least one of:
a type of channel estimation measurement to include in the second fronthaul C-plane message,
a list of SRS ports, from the two or more SRS ports, that indicate to include, for each SRS port in the list of SRS ports, a respective channel estimation measurement metric in the one or more channel estimation measurement metrics in the second fronthaul C-plane message, or
a frequency reporting granularity.

15. A method of wireless communication performed by a radio unit (RU), comprising:
receiving, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions; and
transmitting, as at least part of a second fronthaul C-plane message, one or more channel estimation measurement metrics that are based at least in part on the transmission configuration information.

16. The method of claim 15, wherein the SRS section extension comprises:
a common parameter subsection that indicates a first set of common parameters that are common to each SRS port of the two or more SRS ports and the multiple symbols, a port-specific parameter subsection that indicates a second set of per-port parameters that include port configuration information for an entirety of the multiple symbols used by the two or more SRS ports, and
a symbol-specific parameter subsection that indicates a third set of symbol-specific parameters at include symbol configuration information for each symbol of the multiple symbols used by the two or more SRS ports.

17. The method of claim 16, wherein the common parameter subsection includes, as a common parameter of the first set of common parameters, a numTddMuxGroup field that indicates a number of time division duplex multiplex groups that are associated with the two or more SRS ports,
wherein the port-specific parameter subsection includes, as at least part of the second set of per-port parameters, one or more per-port information segments, and
wherein each per-port information segment includes a tddMuxGrp field that indicates a time division duplex multiplex group that is associated with a respective SRS port of the two or more SRS ports that is associated with the per-port information segment, wherein the symbol-specific parameter subsection includes, as at least part of the third set of symbol-specific parameters, one or more per-symbol information segments, and
wherein each per-symbol information segment of the one or more per-symbol information segments, includes a SymTddMuxGrp field that indicates a time division duplex multiplex group that is associated with a particular symbol of the multiple symbols that is associated with the per-symbol information segment.

18. The method of claim 15, wherein the SRS section extension, for a respective SRS port of the two or more SRS ports, comprises:
common parameter subsection that indicates a first set of common parameters that are common to each SRS port of the two or more SRS ports, and
one or more SRS port configuration subsections that collectively include a second set of per-port parameters that include configuration information for an entirety of symbols used by the two or more SRS ports and a third set of symbol-specific parameters that include symbol configuration information for each symbol of the entirety of the multiple symbols used by the two or more SRS ports,
wherein each SRS port configuration subsection of the one or more SRS port configuration subsection comprises:
a per-port information segment that is associated with a respective SRS port of the two or more SRS ports, and
a symbol-specific parameter subsection that is associated with a set of symbols, from the entirety of the symbols, that is associated with the respective SRS port, and
wherein the per-port information segment includes an srsSymbBitMap field that indicates a symbol bit map that maps each respective bit to a respective symbol index of a respective symbol of the set of the symbols.

19. A non-transitory computer-readable medium storing a set of instructions for wireless communication, the set of instructions comprising:
one or more instructions that, when executed by one or more processors of a radio unit (RU), cause the RU to:
receive, as at least part of a first fronthaul control plane (C-plane) message, a sounding reference signal (SRS) section extension that indicates transmission configuration information associated with two or more SRS ports and one or more transmissions that share one or more air interface resources that span multiple symbols and one or more frequency partitions; and
transmit, as at least part of a second fronthaul C-plane message, one or more channel estimation measurement metrics that are based at least in part on the transmission configuration information.

20. The non-transitory computer-readable medium of claim 19, wherein the SRS section extension comprises:
a common parameter subsection that indicates a first set of common parameters that are common to each SRS port of the two or more SRS ports and the multiple symbols,
a port-specific parameter subsection that indicates a second set of per-port parameters that include port configuration information for an entirety of the multiple symbols used by the two or more SRS ports, and
a symbol-specific parameter subsection that indicates a third set of symbol-specific parameters at include symbol configuration information for each symbol of the multiple symbols used by the two or more SRS ports,
wherein the common parameter subsection includes, as a common parameter of the first set of common parameters, a numTddMuxGroup field that indicates a number of time division duplex multiplex groups that are associated with the two or more SRS ports,
wherein the port-specific parameter subsection includes, as at least part of the second set of per-port parameters, one or more per-port information segments,
wherein each per-port information segment includes a tddMuxGrp field that indicates a time division duplex multiplex group that is associated with a respective SRS port of the two or more SRS ports that is associated with the per-port information segment,
wherein the symbol-specific parameter subsection includes, as at least part of the third set of symbol-specific parameters, one or more per-symbol information segments, and
wherein each per-symbol information segment of the one or more per-symbol information segments, includes a SymTddMuxGrp field that indicates a time division duplex multiplex group that is associated with a particular symbol of the multiple symbols that is associated with the per-symbol information segment.
